(19) United States
(12) Patent Application Publication
(10) Pub. No.: US 2003/0028610 A1
(43) Pub. Date: Feb. 6, 2003

(54) Peer-to-peer file sharing system and method using user datagram protocol

(76) Inventor: Christopher Joel Pearson, Minneapolis, MN (US)

Correspondence Address: KATTEN MUCHIN ZAVIS, Attention: Patent Administrator, Suite 1600, 525 West Monroe Street, Chicago, IL, 60661-3693, US

(21) Appl. No.: 09/921,731

(22) Filed: Aug. 3, 2001

(51) Int. Cl. G06F 15/167; G06F 15/16

(52) U.S. Cl. 709/213; 709/232; 709/245

(57) ABSTRACT

A network-based file-sharing system includes a first host computer and a plurality of other host computers, each host computer having a processing unit and a storage. The first host computer is programmed to generate from the plurality of other host computers a list of other host computers where a user-selected file is stored. The first host computer is further programmed to select a second host computer from the list of other host computers based on an indication of a transfer time from the second host computer to the first host computer and to retrieve at least a portion of the particular file from the second host computer using User Datagram Protocol data packets.

Files may be shared over a wide-area network by connecting a plurality of hosts over the wide-area network; coupling a registry server independent of the hosts to the wide-area network for maintaining a registry containing, for each of a plurality of files, a message digest uniquely identifying the file and an indication of restriction status of the file; and providing a first host having a processing unit, a storage, and a first set of machine instructions storable in the storage and executable by the processing unit for retrieving a user-selected file from at least one of the hosts coupled to the first host via the wide-area network. Access to the file by the first host from the plurality of hosts is based on the indication in the registry of restriction status of the user-selected file.

### TECHNICAL FIELD

The present invention relates generally to file sharing and, more particularly, to a method and system for use in sharing files on a peer-to-peer basis among host computers on a computer network using User Datagram Protocol (UDP).

### BACKGROUND

File sharing systems for sharing files (e.g., audio, video, text, and other data files) over a wide-area computer network such as the Internet, for example, typically employ the well-known Transmission Control Protocol (TCP) and Internet Protocol (IP) addressing and communication protocols for transferring files from one computer to another. However, this file-transfer scheme using TCP/IP is not useful in some computer network configurations. By way of example, where a file is stored at a computer that is part of a local-area network (LAN) coupled to a wide-area network (WAN), such as, for example, the Internet by an address-translating device, such as a proxy server, a router, or any other suitable device with address translation capabilities, and a user of another computer that is part of another LAN coupled to the WAN by another address-translating device seeks to retrieve the file from the former computer, the TCP/IP file-transfer scheme does not permit the file to be transferred. The reason for this is that, as will be appreciated by those of ordinary skill in the art, the address-translating device that connects the computers on a LAN to a TCP-based WAN must assign and open a communication port to a target computer on the LAN in order for communication to take place from a requester computer on the WAN through the address-translating device to the target computer on the LAN. However, until such a communication port is opened, assigned to the target computer on the LAN, and made known to the requester computer on the WAN, by the address-translating device there is no way for the requester computer on the WAN to contact, identify, or even “know about” the target computer on the LAN. Consequently, there is no way for the requester computer to provide an instruction to the address-translating device to open a communication port through which the requester computer on the WAN can communicate with the target computer on the LAN.

Further, even if a communication port had been assigned and opened to allow for communication to take place between a computer on a LAN through an address-translating device of the LAN and a computer on the WAN, such a communication port remains open for a short time interval in a TCP-based network environment until a time-out event occurs (e.g., until the port ceases to remain active) after a predetermined short amount of time. After that time elapses, if the connection to the communication port is not actively used, the communication port closes and communication is no longer possible until a new communication port is assigned and opened for the communication. As a result, TCP-based communication is substantially limited for the vast numbers of computers that operate on a local-area network coupled to the Internet or some other WAN only via a address-translating device.

Moreover, even where files are to be shared among computers coupled directly to a WAN, with no intervening address-translating device, the communication capabilities of TCP-based networks are often slow to initialize, and suffer the further disadvantage of time delays inherent in the TCP protocol, particularly for transferring large data files such as those containing data-intensive audio or video information. As a result, the use of TCP-based communication involves significant time delays which renders large-scale real-time transfer of media files prohibitively slow and inconvenient.

Another aspect of prior file-sharing systems involves the tracking of shared files and the authorization of sharing files, such as to enforce copyright rights and other access restrictions that may be imposed on the sharing of data files such as song files, for example. Many prior file-transfer systems have not provided a satisfactory mechanism for implementing such access restrictions.

### SUMMARY

The present invention relates to a method and system and software for sharing files over a network that is faster, more reliable, and more robust than prior peer-to-peer file-sharing systems and which may provide for monitoring files that are restricted from being shared or which may be shared only upon payment of a fee.

According to one aspect of the present invention, a system for sharing files among a plurality of computers on a wide-area network may comprise first and second networked computers, wherein a user-selected file is reliably transferred from any one of the computers to any other one of the computers using User Datagram Protocol data packets. In one embodiment, the first networked computer is coupled to the wide-area network via a first address-translating device and the second networked computer is coupled to the wide-area network via a second address-translating device.

According to another aspect of the invention, a network-based file-sharing system comprises a first host computer and a plurality of other host computers, each host computer having a processing unit and a storage. The first host computer may be programmed to generate from the plurality of other host computers a list of other host computers where a user-selected file is stored, to select a second host computer from the list of other host computers based on an indication of a transfer time from the second host computer to the first host computer, and to retrieve at least a portion of the particular file from the second host computer using User Datagram Protocol data packets. The first host computer preferably is programmed to select from the list of other host computers a second host computer having a fastest transfer time to the first host computer and/or to select as the second host computer the host computer from the list of other host computers with the fastest transfer time from the second host computer to the first host computer.

According to another aspect of the present invention, a system for sharing files over a wide-area network comprises a first plurality of hosts connected over the wide-area network and a first host having a processing unit, a storage, and a first set of machine instructions storable in the storage and executable by the processing unit for retrieving a respective portion of a user-selected file from each of a second plurality of hosts selected from the first plurality of hosts and coupled to the first host via a network. The first host preferably resides on a first local-area network coupled to the wide-area network via a first address-translating device, and the second host preferably resides on a second local-area network coupled to the wide-area network via a second address-translating device. The first address-translating device preferably is coupled to the second address-translating device only via the wide-area network, and the first local-area network preferably is distinct from the second local-area network. Also preferably, User Datagram Protocol data packets are used to retrieve the respective portion of the user-selected file from each of the second plurality of hosts.

According to another aspect of the present invention, a system for sharing files over a wide-area network includes a plurality of hosts connected over the wide-area network, a registry server independent of the hosts and coupled to the wide-area network for maintaining a registry containing for each of a plurality of files a message digest uniquely identifying the file and an indication of restriction status of the file, and a first host having a processing unit, a storage, and a first set of machine instructions storable in the storage and executable by the processing unit for retrieving a user-selected file from at least one of the hosts coupled to the first host via the wide-area network, wherein access to the file by the first host from the plurality of hosts is based on the indication in the registry of restriction status of the user-selected file.

According to yet another aspect of the present invention, a network-based file-sharing system includes a first host computer and a plurality of other host computers, each host computer having a processing unit and a storage, the first host computer having generating means for generating from the plurality of other host computers a list of other host computers where a user-selected file is stored, selecting means for selecting a second host computer from the list of other host computers based on an indication of a transfer time from the second host computer to the first host computer, and retrieving means for retrieving at least a portion of the particular file from the second host computer using User Datagram Protocol data packets.

According to still another aspect of the present invention, files are shared over a wide-area network according to a method wherein a plurality of hosts are connected over the wide-area network, a registry server independent of the hosts is coupled to the wide-area network for maintaining a registry containing, for each of a plurality of files, a message digest uniquely identifying the file and an indication of restriction status of the file, and a first host is provided having a processing unit, a storage, and a first set of machine instructions storable in the storage and executable by the processing unit for retrieving a user-selected file from at least one of the hosts coupled to the first host via the wide-area network. Access to the file by the first host from the plurality of hosts is based on the indication in the registry of restriction status of the user-selected file.

In accordance with still a further aspect of the invention, a computer-based system for sharing files over a computer network including a requesting host computer and a plurality of other host computers coupled to the first host computer via a network, the requesting host computer comprising a processing unit and a storage and being programmed with machine instructions for acquiring an indication of a user-selected file, for generating at the requesting host computer from among the plurality of other host computers a list of those of the other host computers where the user-selected file is stored, for selecting a source host computer from the list of other host computers based on an indication of a transfer time from the source host computer to the requesting host computer, and for retrieving at least a portion of the particular file from the second host computer using User Datagram Protocol data packets.

### BRIEF DESCRIPTION OF THE DRAWING

FIG. 1 is a high-level illustration of an exemplary network of host computers, including a plurality of local sub-networks, which may embody the method and system of the present invention may be employed;

FIG. 2 is a block-diagram illustrating one exemplary embodiment of a host computer which may be used in implementing the method and system of the present invention;

FIG. 3 is a flowchart illustrating one exemplary embodiment of programming for building a list of host computers present on a computer network for sharing files in accordance with the present invention;

FIG. 4 is a flowchart illustrating one exemplary embodiment of programming for searching remote host computers from a local host computer for a file specified by a user of the local host computer;

FIG. 5 is a flowchart illustrating one exemplary embodiment of programming for transferring a file from one or more remote host computers to a local host computer;

FIG. 6 is a flowchart illustrating one exemplary embodiment of programming for retrieving a file from a remote host computer to a local host computer where both the remote host computer and the local host computer are on respective local sub-networks;

FIG. 7 is a flowchart illustrating one exemplary embodiment of programming for administering a file registry in accordance with the principles of the present invention.;

FIGS. 8-47 are pictorial representations of screen displays illustrating various features of one exemplary embodiment of a file-sharing system in accordance with the present invention as described in more detail herein.

### DETAILED DESCRIPTION

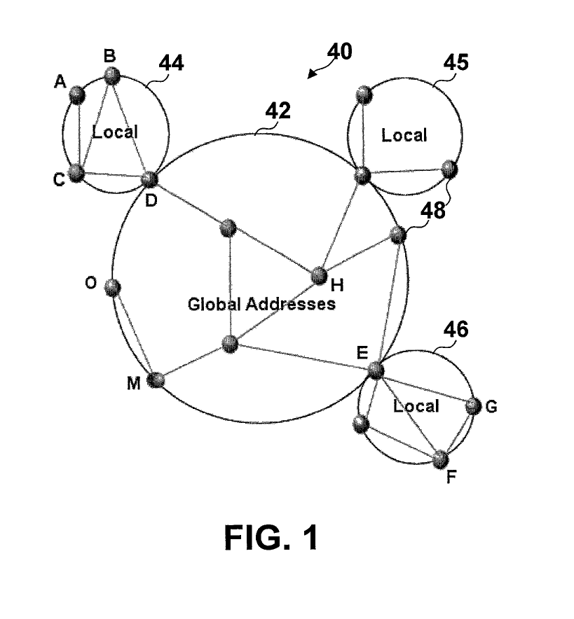

One exemplary computer network 40 which may be employed to implement a file-sharing system and method in accordance with the principles of the present invention is illustrated in FIG. 1. As shown, the computer network 40 includes a wide-area network or WAN 42 having a plurality of host computers 48 (e.g., host computers D, E, H, M, O, etc.) coupled thereto. The computer network 40 may also include one or more local-area networks or LAN's 44, 45, 46 coupled to the computer network 40 via a respective address-translating device (e.g., the address-translating device or host computer D of the LAN 44). One or more host computers 48 is also present on each LAN 44, 45, 46 (e.g., host computers A, B, and C of the LAN 44, and host computers F and G of the LAN 46).

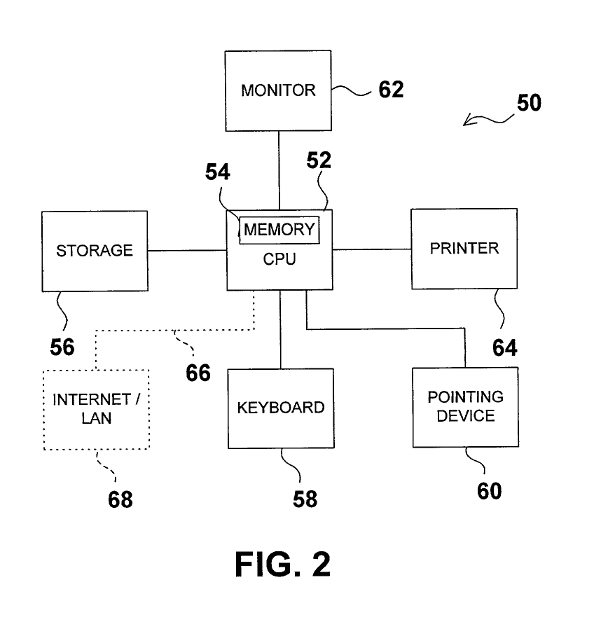

FIG. 2 depicts, in block diagram form, one exemplary embodiment of a computer system 50 which may be used to implement the functionality of a host computer 48 in accordance with the principles of the present invention. As shown in FIG. 2, each such computer system 50 includes a central processing unit or CPU 52 coupled with random-access and read-only memory 54, any other suitable memory or storage medium 56, a keyboard 58, a mouse or other suitable pointer control 60, a video monitor 62, an optional printer 64, a connection 66 to the Internet or other network (represented by a box 68 shown in dashed lines in FIG. 2), and any other desired peripheral devices (not shown). The storage 56 may comprise a fixed hard disk, a floppy disc, a compact disc (CD) or digital video disk (DVD), or any other suitable memory or storage medium, including, for example, the read-only memory (ROM) or random access memory (RAM) of the computer system 50.

In accordance with the principles of the present invention, such computer systems 50 are programmed to generate from other such computer systems 50 on the same network a list of other computer systems 50 where a user-selected file is stored. By way of example and not limitation, a user-selected file to be shared on a system in accordance with a present invention may comprise a music or sound file, a video file, a graphic image file, or a data file of any sort. More particularly, the storage 56 or the memory 54 of the computer system 50 contains or may be loaded with software for carrying out the method of the present invention. In some embodiments, such software would include a set of machine instructions storable in the storage 56 or the memory 54 and executable by the CPU 52 for retrieving a respective portion of a user-selected file from each of a plurality of other host computers that are coupled to the computer 50 via a network.

The embodiment illustrated herein is adapted to permit file sharing among computers on a wide-area network and/or computers residing on a local-area network coupled to a wide-area network via a address-translating device, which may be implemented in a suitably programmed computer, for example. Specifically, the illustrated system may share audio, video, graphic, animation, text, or other data files.

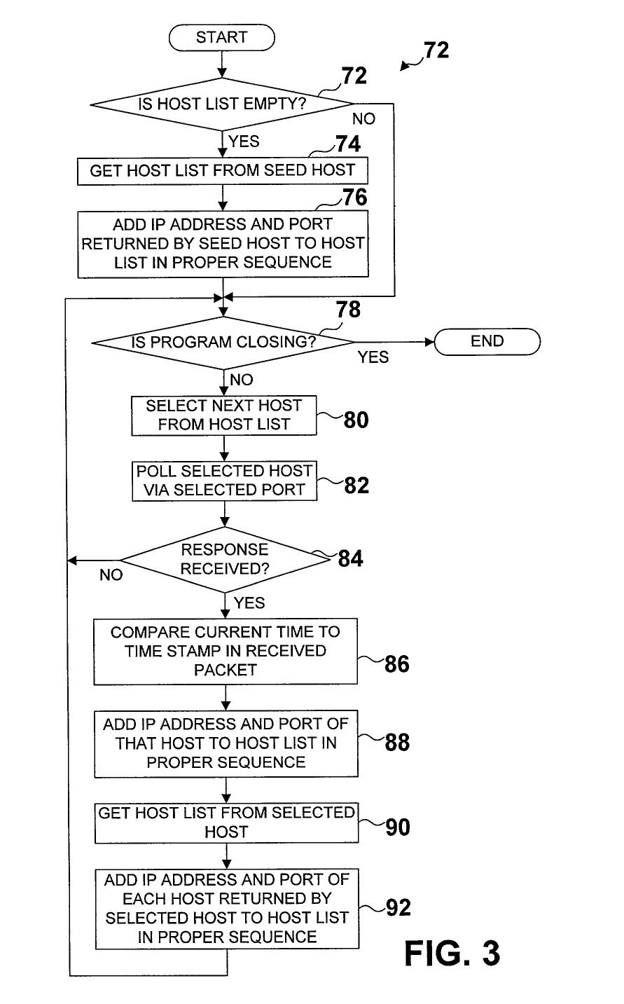

FIGS. 3-7 depict high-level flowcharts illustrating one exemplary embodiment of programming associated with the functionality of the invention. It should be understood that the functionality described herein of the various blocks or routines of the flowcharts of FIGS. 3-7 may be implemented in many ways, using any desired programming language or program design techniques, including sequential, procedural, modular, or object-orientated programming or any combination thereof. Particular instructions, subroutines, or subprograms used to implement such functionality can be readily developed by those of ordinary skill in the art and need not be described in detail here.

A flowchart 70 is shown in FIG. 3 for generating at a host computer 50 a list of other host computers present on the peer-to-peer network to which the host computer 50 is coupled at any given time. Each host computer present on a network embodying the present invention maintains a list of other hosts available on the network. An entry appears in that list for each such host, the entry including, for example, an Internet Protocol or IP address and a port number, which together identify a corresponding host computer. The flowchart 70 may represent functionality implemented on any given one of the host computers on the network and is therefore described in general terms herein, and the applicability and transferability of the described functionality to any of the host computers on the peer-to-peer network should be understood.

As shown in FIG. 3, a block 72 determines whether the host list of the given host computer is empty (i.e., whether more hosts are needed in the host list). If so, a block 74 retrieves from a seed host computer, which is generally always connected to the network, a host list which is always maintained on the seed host computer. A block 76 then adds to the host list of the given host computer each IP address and port number returned by the seed host computer in proper sequence. More particularly, the entries for the various host computers on the host list received from the seed host are entered into the host list of the given host computer according to how quickly each such host computer returns information or data to the given host computer (i.e., according to the responsiveness of the various host computers). Thereafter, control passes to a block 78 which determines whether the program implementing the functionality of the flowchart 70 of FIG. 3 is closing. If the block 72 determines that the host list of the given computer is non-empty, the blocks 74 and 76 are bypassed, and control passes directly to the block 78. To ensure that the system becomes aware of new hosts at least occasionally, the seed host computer or server may be polled on a regular or variable basis, and the hosts located via the seed host computer may be chosen from the host list of the seed host computer or server at random, if desired, rather than being chosen from the top of the host list of the seed host computer or server.

If the block 78 determines that the program is closing (or alternatively, for example, that execution of the illustrated protocol program or module is stopping), execution of the program or the protocol module ends. Otherwise, a block 80 selects the “next” host from the host list of the given computer. It should be noted that on the first pass through this portion of the programming represented by the flowchart 70, the “next” host computer, as referred to in block 80, refers to the first host computer on the host list of the given host computer. A block 82 then polls the host computer selected by the block 80 via a selected port used by the given host computer for communicating with the other computers on the network. A block 84 then determines whether a response has been received from the polled host computer. This response would comprise a packet of data including at least, for example, a time stamp which can be compared to an indication of a current time to determine a transfer time for transferring a data packet from the polled host computer to the given host computer. If the block 84 determines that no response has been received, then control returns to the block 78 to again determine whether the program module is closing. If the block 84 determines that a packet was received from the selected host in response to the polling of the block 82, then a block 86 compares the current time to the time stamp contained in the received packet to the current time. A block 88 then adds the IP address and port of the host from which the packet was received to the host list of the given host computer in proper sequence based on the time stamp contained in the received packet. A block 90 then gets the host list from the selected host computer (i e., a host that was polled by the block 82), such as if more host computers are needed, a block 92 adds the IP address and port number of each host computer on the host list of the selected host computer to the host list of the given host computer in proper sequence, based on characteristics of the polled host computer and/or the host computers on the host list of the polled host computer, such as, for example, responsiveness, disk space, hard-drive speed, processor speed, network connection speed, average “true” bandwidth, idle processor time available, user interaction statistics, files available for sharing, files currently being transferring, etc. Control thereafter returns to block 78 to again determine whether the program represented by the flowchart 70 is closing. As stated above, when the block 78 eventually determines that the program module is closing, execution of the program module represented by the flowchart 70 ends.

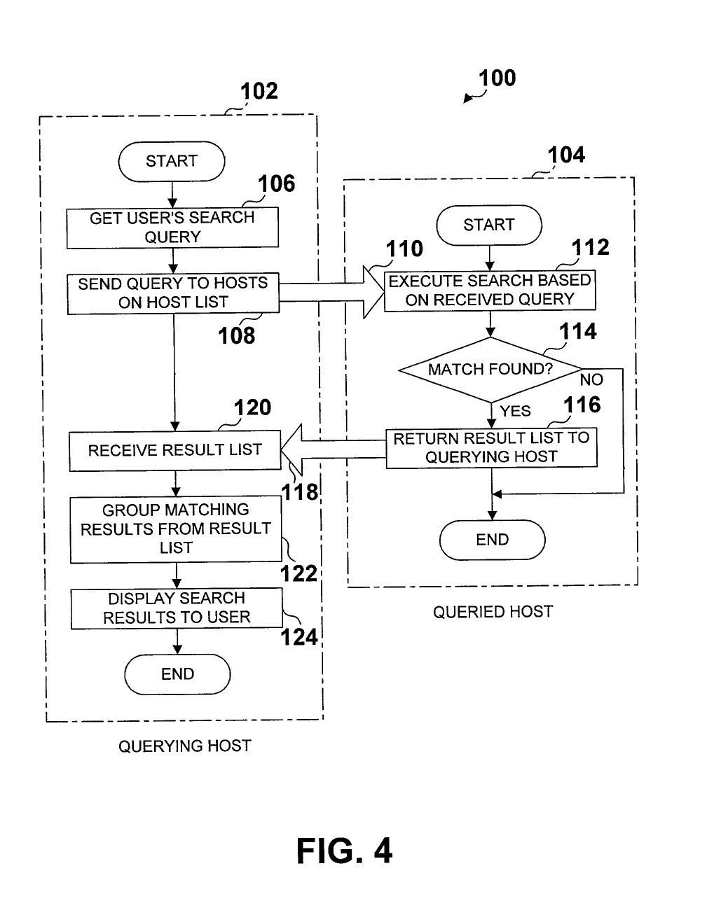

FIG. 4 depicts a hybrid flowchart and data flow diagram 100 illustrating one exemplary embodiment of a process by which a first host computer or querying host 102 searches for a user-specified fileon one or more other host computers or queried hosts 104. This file may be described by many different qualities or characteristics of the file, such as its name, size, bitrate, length, media time length, and particularly the MD5 message digest or file identifier of the file when searching for a particular file. As shown in FIG. 4, functionality implemented at the first host computer 102 is shown within the dashed-line box identified with reference numeral 102, and functionality implemented on the queried host computer 104 is shown within the dashed-line box identified with reference numeral 104. Initially, a block 106 obtains a search query from a user of the querying host computer 102. A block 108 then sends the user's search query to one or more hosts computers 104 on the host list of the querying host computer 102, each such host computer 104 thereby becoming a queried host computer. The query sent from the querying host computer 102 to the queried host computer 104 is represented in FIG. 4 by an arrow 110 and, in one embodiment, comprises a file name for the file or song for which a search is being performed, an indication of the artist or performer of the song, and an indication of the file type of the file for which the search is being performed. Again, exemplary file types include .mp3, .avi, .jpg, .bmp, or gif, or any other file types. The illustration of FIG. 4 depicts this query being sent to one queried host computer 104. However, as will be readily appreciated by those of ordinary skill in the art, the query may be concurrently sent to a plurality of queried hosts 104 (e.g., up to 40 or more hosts).

When such a query is received by a queried host 104, a block 112 (representing functionality implemented within the queried host 104) executes a search based on the received query. A block 114 then determines whether the search executed by the block 112 successfully located a file meeting the criteria specified by the search query. If so, a block 116 returns a result list to the querying host 102, the returned result list being represented by an arrow 118 in FIG. 4. If the block 114 determines that no matching file was found, the block 116 is bypassed and execution of the search query handling routine within the queried host 104 ends.

The result list returned to the querying host 102 by the block 116 preferably comprises but is not limited to an entry including a file name, a file identifier, and a source host address for each file stored in the queried host computer 104 that matched the criteria specified by the search query 110. Of course, a count limit may be imposed on the result list if desired such that no more than, for example, 25 matching files on the queried host computer 104 will be initially included in the result list returned to the querying host computer 102. Further results from any host can be requested at any time.

In the querying host computer 102, programming corresponding to a block 120 receives the result list 118 from the queried host computer 104, and a block 122 groups matching results from the result list together. In other words, if multiple files included in the result list 118 have identical identifying numbers but different file names, those files are listed only once in the search results. Programming corresponding to a block 124 then displays the search results to a user of the querying host computer 102.

In the event that the querying host computer 102 does not receive a response from a queried host computer 104, the user of the querying host computer 102 preferably is notified that no files satisfying the user's search query were found. Optionally, the search process can be repeated a predetermined number of times, or until at least one file is found that meets the user's search query, if desired. As will also be appreciated by those of ordinary skill in the art, using a conventional multiple document interface (MDI), multiple concurrent searches can be performed by a querying host computer 102 in the foregoing manner.

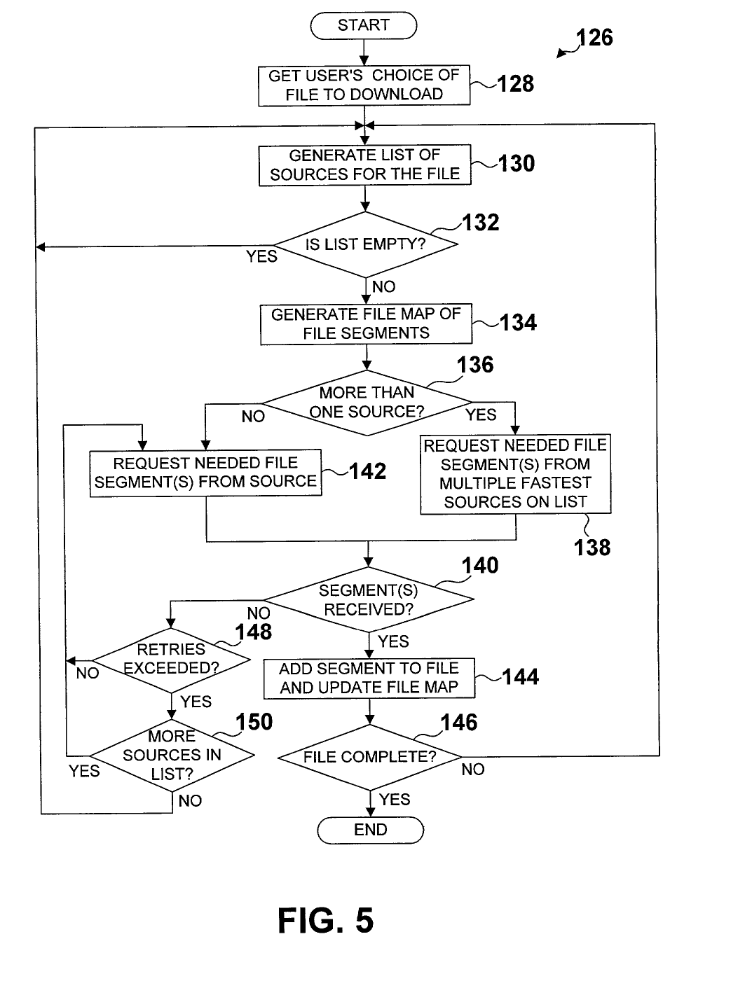

FIG. 5 depicts a flowchart 126 representing programming for transferring a file from one or more host computers on which the file is stored to a further host computer at which a user requested the file, such as following a search that the user conducted for the file on other host computers. As shown in FIG. 5, a block 128 acquires from a user of a requesting host computer the user's choice of a file to download, and a block 130 generates a list of sources (i.e., other host computers) for that file, whether by developing the list in real-time or by retrieving and using the result list generated by the programming illustrated in the flowchart of FIG. 4. A block 132 then determines whether the list of sources for the file is empty. Optionally, at this juncture, an attempt could be made to generate a further list of sources for the requested file, such as by control returning to the block 130 to again seek a list of sources for the file that the user selected for download (such as by the process illustrated in FIG. 4, for example). If the block 130 determines that the list of sources for the file is non-empty (i.e., if at least one source host computer exists for that file), then a block 134 generates a file map of file segments making up the file. The map of file segments substantially comprises a checklist used to keep track of which file segments of a requested file have been received and which have not. More particularly, the block 134 conceptually subdivides the requested file into an array of potentially thousands of file segments, each of which contains a portion of the data making up the file.

A block 136 then determines whether the non-empty list of sources for the requested file includes a single source or multiple sources. If the block 136 determines that only a single source appears on the source list generated by the block 130, then a block 132 requests a needed file segment (i. e., one that has not already been received, as indicated by the file segment map, and preferably the next sequential file segment that has not already been received) from the single source for the file appearing on the source list. Control then passes to a block 140 which determines whether the requested segment of the file was received by the requesting host computer. If so, then a block 134 adds the received file segment to the file and updates the file segment map to reflect that that segment has been received. A block 146 then determines from the file segment map whether the file is complete (i.e., whether all segments of the file have been received, as indicated by the file segment map). If so, then programming associated with the flowchart 126 of FIG. 5 ends. If not, then control returns to the block 130 to re-generate a list of sources for the file inasmuch as other host computers having the file may have come on-line on the peer-to-peer network since the current list of sources was generated. If the block 136 determines that the source list includes more than one source for the requested file, then a block 138 requests a needed file segment of the file from at least one, and preferably from a plurality, of the fastest sources on the source list (i.e., those with the most responsiveness to the requesting host computer, which will generally be those closer to the top of the host list), and control passes to a block 140. In a preferred embodiment, while a file is being transferred, the source list of source host computers from which that file may be obtained is continually updated and resorted based on the actual responsiveness of the source host computer(s) from which the file is being obtained, and the when source host computers from which the file is being transferred cease to be the “most responsive” or fastest, transferring of the file proceeds using the most responsive source host computers according to the updated or re-sorted source host list. Making the request from a plurality of sources (e.g., from as few as two to as many as ten or more) provides redundancy in case a segment of the file is unable to be transferred from a source from which it is requested.

If the block 140 determines that the requesting host computer did not receive the requested file segment (S), then a block 148 determines whether a predetermined maximum number of segment retrieval retries have been exceeded. The maximum number of tries is set programmatically and is not a forced default of the Internet Protocol. This maximum number can be 10, for example. Even where the maximum number of retries is exceeded, the same source can still be retried later (e.g., after a new list of sources for the requested file is generated). If the maximum number of retries has not been exceeded, then control returns to the block 142 to request the needed file segment from the source from which that segment had already been requested. If the block 148 determines that the number of retries has been exceeded then a block 150 determines whether additional sources exist in the source list for the requested file. If so, then control returns to the block 142, which then requests the needed file segment from another source on the source list. Again, sources with the shortest transfer time to the requesting host are tried first. If the block 150 determines that no additional sources remain on the lists, then control returns to the block 130 which generates an updated list of sources for the requested file. Consequently, the illustrated embodiment of the file-sharing software application of the present invention will continuously persist in its search for new sources, if needed, and will also reattempt downloads from the previous sources, until the retrieval of the requested file is completed.

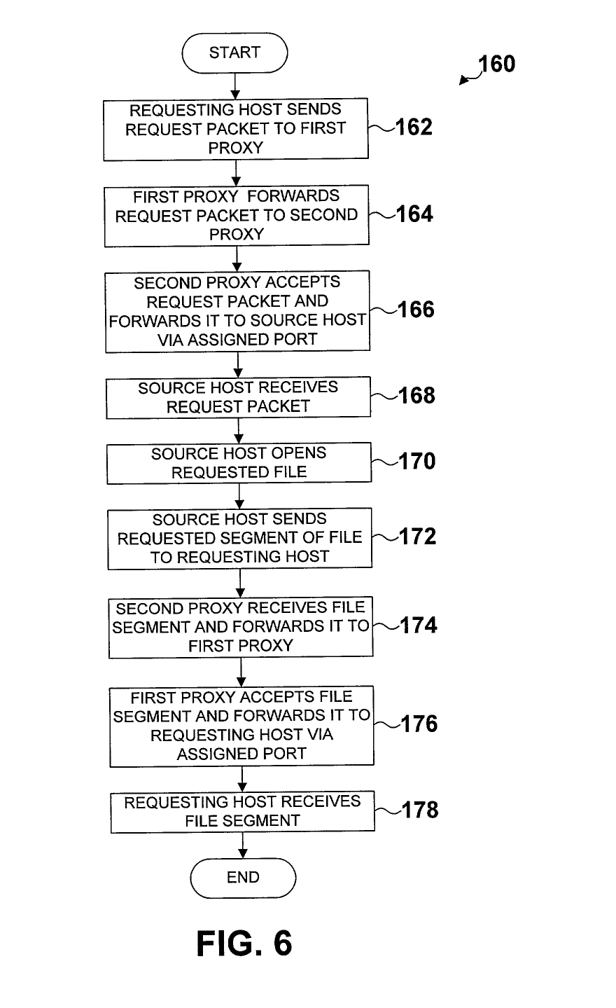

FIG. 6 depicts a flowchart 160 illustrating programming associated with “dual-proxy” retrieval of file segments. More particularly, in the circumstance where a requesting host computer residing on a local area network coupled to a wide-area network via a first address-translating device seeks to retrieve a segment of a requested file from a source host computer residing on a second local-area network coupled to the wide-area network via a second address-translating device, programming corresponding to the flowchart 160 of FIG. 6 permits the segment to be retrieved from the source host computer by the requesting host computer via the first and second address-translating devices and the intervening wide-area network.

For this segment retrieval to succeed, two conditions must be met. First, a port must already be open on the second address-translating device for the source host computer in order for the first host computer to be able to send a packet to the second address-translating device for the source host computer. Second, the first host computer must be aware that the second host computer exists (i.e., that it is coupled to the WAN via an address-translating device), and must further possess the port number that the second address-translating device opened for the source host computer. More specifically, unless the source host computer sends a signal to the second address-translating device, the second address-translating device does not know the number of the data port on which the source host computer is awaiting data, and, consequently, when the requester computer sends a request for a segment of the file, the second translating device cannot forward the request to source host computer.

TCP is a connection-oriented protocol which provides communication over a connection on a port established between two and only two machines. In a TCP-based file transfer, because the port opened by the source host computer connects to or “binds” exactly one other device, when the requester computer sends a request for a segment of the file, the attempt to retrieve the requested segment fails, because the second address-translating device does not know the number of the data port on which the source host computer is awaiting data. With TCP, this is resolvable only by forwarding packets through a connection with a third host computer or other device located directly (ie., not through a proxy server or other address-translating device) on the WAN that interconnects the two LAN's. This necessitates the overhead of maintaining a second connection and a programming method by which the third host computer can manage the forwarding of data between the requester computer and the source host computer.

The present invention employs UDP, which is a so-called “connection-less” protocol, meaning there is no “bind” between two computers. Once the source host computer transmits from a UDP port, the address-translating device of the LAN on which the source host computer resides is thereafter aware that the source host is using that port. A UDP port assignment typically remains in place until a default expiration time elapses. In the system and method of the present invention, the expiration or time-out is avoided because a host computer uses the same port for all of its communication. Because of the continual re-requesting of segments of the requested file from the source host computers on the source host list of the requesting host computer, the communication ports assigned by the first and second address-translating devices or proxy servers remain open to allow the file segment requests (and the returned file segments themselves) to be transferred between the requester computer and the various source host computers. Since the port opened and assigned to the source host computer on the second address-translating device is not bound to any other host, the request from the requester computer is accepted by the second address-translating device and forwarded to the source host computer.

As shown in FIG. 6, through programming associated with a block 162, a requesting host computer sends a request packet to a first address-translating device through which the local-area network occupied by the requesting host computer is coupled to a wide-area network. The request packet preferably comprises an MD5 identifier or other unique identifier of a file sought to be retrieved by the requesting host computer and a segment identifier, pointer, or index that identifies (in the file segment map) the particular portion or segment of that file to be retrieved in connection with the request. The first address-translating device then forwards the request packet to a second address-translating device through which a local-area network occupied by a source host computer is connected to the wide-area network (block 164). Through programming associated with a block 166, the second address-translating device accepts the request packet and forwards the request packet to a source host computer via a port that the second address-translating device assigned to the source host computer and opened to allow for communication between the source host computer and the wide-area network.

The source host computer receives the request packet (block 168), and opens the requested file (block 170). The source host computer then sends the requested segment of the file to the requesting host (block 172). In particular, the second address-translating device receives the file segment from the source host computer and forwards it to the first address-translating device (block 174). The first address-translating device receives the file segment and forwards it to the requesting host via a port assigned to the requesting host computer by the first address-translating device (block 176). Finally, the requesting host computer receives the requested file segment from the source host computer through the above-described dual-proxy communication path that interconnects the first and second host computers (block 178). Thus, in accordance with the principles of present invention, communication is possible between first and second host computers which reside on separate local-area networks, each of which is connected to a wide-area network, via a proxy server or any other suitable address-translating device.

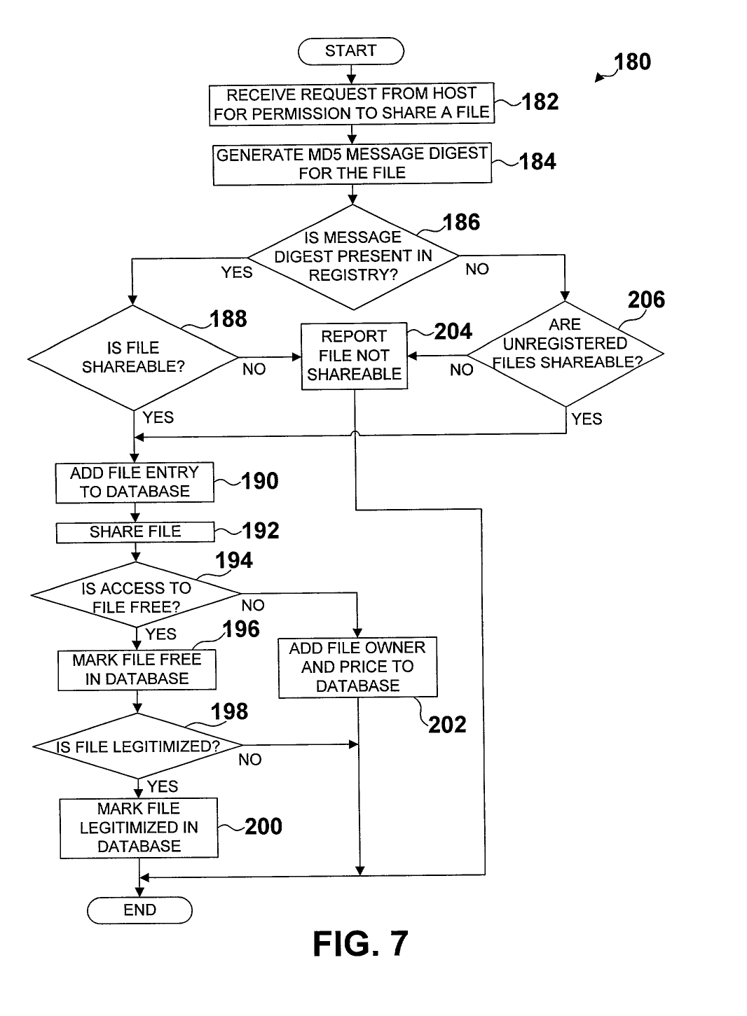

FIG. 7 depicts a flowchart 180 illustrating programming for maintaining a registry of identifiers (such as the well-known MD5 identifiers, for example) for identifying files to be shared in accordance with the principles of the present invention and for keeping track of whether sharing of particular files is permitted or restricted. By way of example and not limitation, particular files may be restricted to protect copyright and other interests of the owners of such files or to ensure that any payment required for the sharing of an otherwise restricted file is made before the restriction is lifted so that the file may be shared. Before a file transfer is initiated, both the source host computer and the requester computer may check to determine whether the file to be transferred is actually allowed to be shared.

As shown in FIG. 7, through programming associated with a block 182, a user on a host computer chooses a file to share. A block 184 generates (usually prior to authentication of the file) a unique alphanumerical identifier or message digest, such as a digest derived according to the well-known MD5 message digest algorithm, for use by the various host computers of the file-sharing system in identifying and distinguishing files to be searched and/or shared. As described below, for large files, the generating of this message digest can be a time-consuming process, and means may be provided for providing a user with a periodic report on the progress of the calculation (e.g., with a graphical progress bar, for example) and the digest and other data is sent to a file-sharing administration server computer, which may be coupled to the wide-area network 42 (FIG. 1), as a request for permission to share a specified file. The file-sharing administration server computer maintains a database or registry of those files for which “permission to share” is required. Individuals or entities owning copyright rights to particular files may register those files with a file-sharing administrator that manages the database associated with the file-sharing administration server computer so that suitable restrictions may be imposed on sharing of those files. The database or registry also may include for each registered file a record of the amount of the fee, if any, that must be paid by a user in order to receive (i.e., download or share) that file and an indication of whether the file is legitimized (i. e., whether an entry for the file exists in the file-sharing administration server which indicates that sharing of the file is permissible via the file-sharing system of the present invention.

Once a request for permission to share a file is received, a block 186 determines whether that message digest is present in the registry or database of the file-sharing administration server computer. If it is, then a block 188 determines, from the record in the registry corresponding to the requested file, whether the requested file is sharable. If the requested file is sharable, then a block 190 adds a file entry (which may include, among other things, a file name, a file length, and an MD5 or other suitable message digest for the file, and any information as to the status of the file for sharing or copyright purposes to the database, and a block 192 is able to share the file with any host computer of users who requested the file. A block 194 then determines whether access to the file is free. If so, then a block 196 marks the file as “free” in the database. A block 198 then determines whether the file is legitimized. If so, then a block 200 marks the file as “legitimized” in the database and execution of the routine represented by the flowchart 180 ends. If the block 198 determines that the file is not legitimized, then the block 200 is bypassed, and execution of the routine ends without the file being marked as legitimized. In the case of a non-legitimized file, the process of legitimizing the message digest for that file with the registry will be attempted periodically, for example when the program starts up and/or each time the file is shared or transferred until the file is legitimized. If the block 194 determines that access to the file is not free, then a block 202 adds the file owner and price for sharing the file to the database, and execution of the routine represented by the flowchart 180 ends. If the block 188 determines that the requested file is not shareable, then a block 204 reports the file as “not sharable,” and execution of the routine represented by the flowchart 180 ends. If the block 186 determines that the message digest of the requested file is not present in the registry, then the requested file is not registered. In that event, a block 206 determines whether unregistered files are shareable via the file-sharing system. This determination may simply be an application of a default rule adopted by the administrators of the file-sharing system (i.e., that unregistered files are per se sharable or not shareable). In any case, if the block 206 determines that unregistered files are not shareable, then the requested file is reported as “not shareable” by the block 204, and execution of the routine represented by the flowchart 180 ends. If the block 206 determines that unregistered files are shareable, then control passes to the block 190 and processing for the requested file continues as described above.

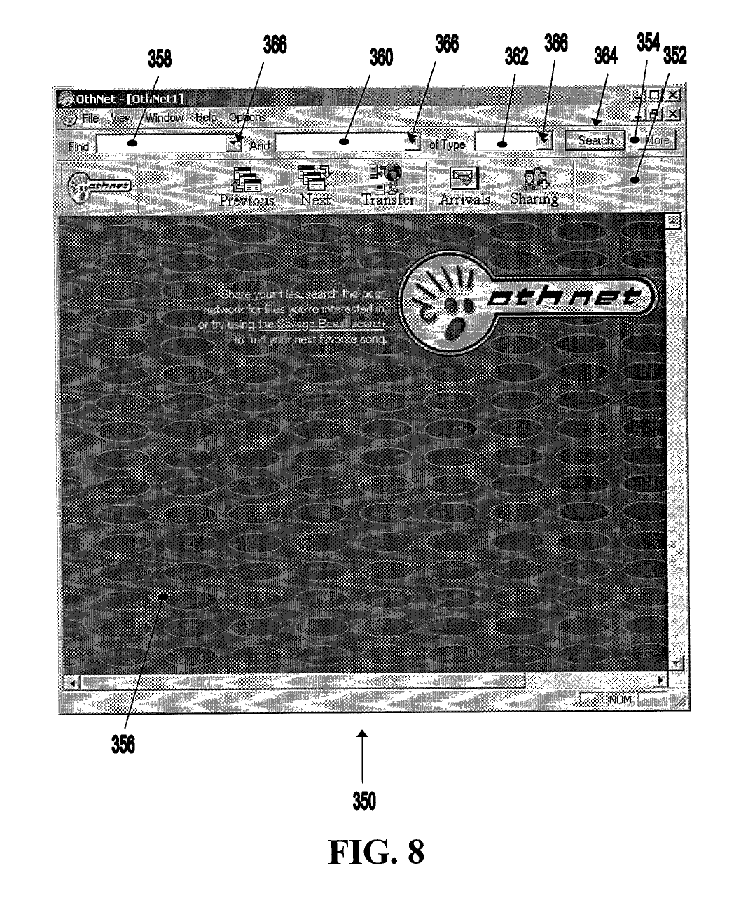

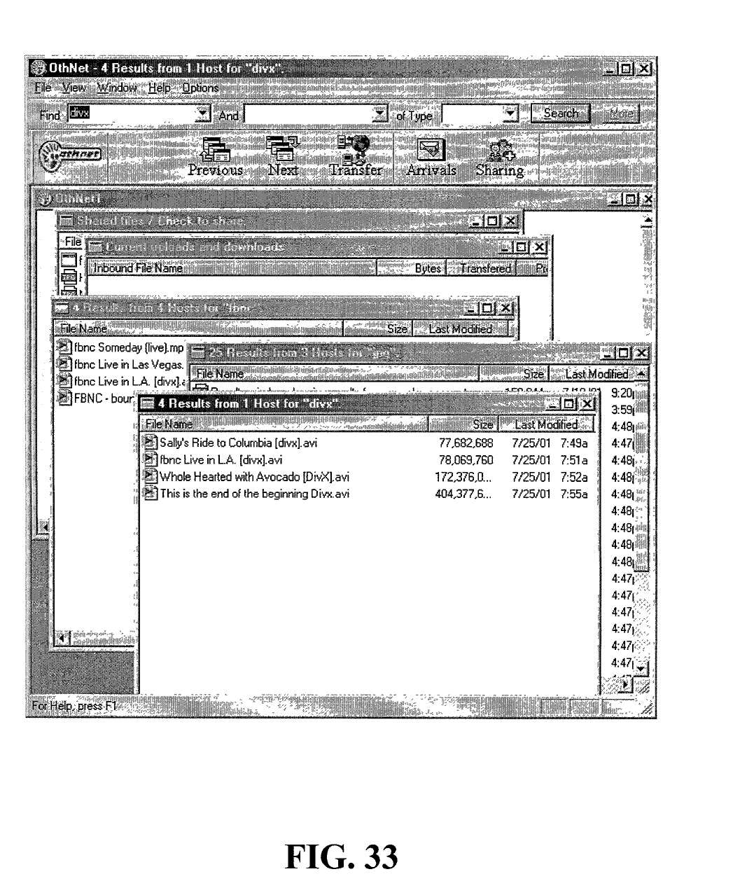

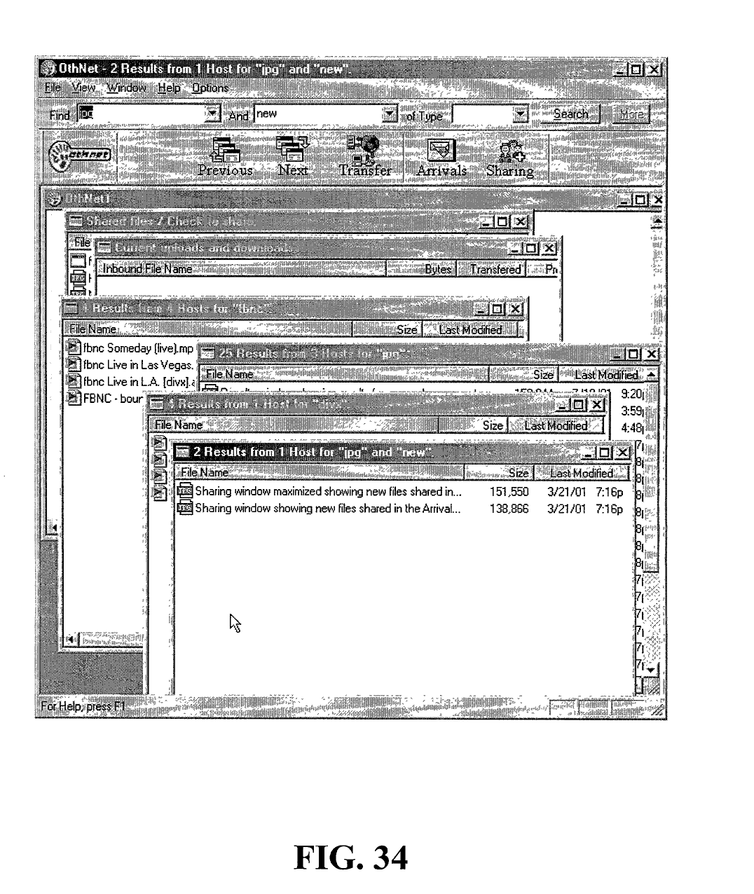

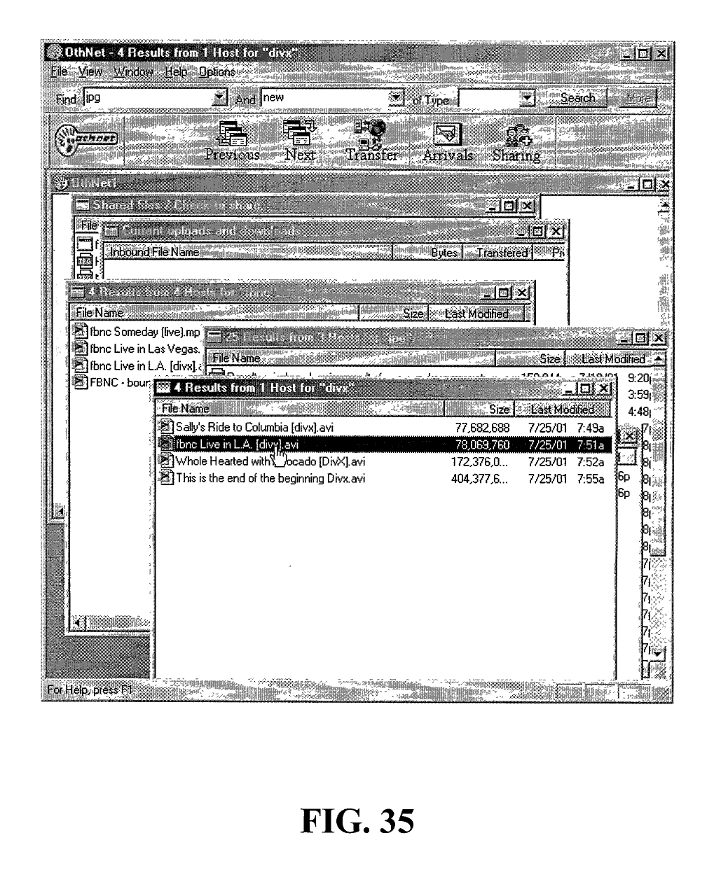

FIGS. 8-47 depict screen displays that illustrate an exemplary embodiment of a graphical user interface to a host computer in a file-sharing system according to the present invention. Of course, any suitable interface may be used, and more or fewer features may be provided. However, the interface shown in FIGS. 8-47 and described herein embodies many common features of Windows-based interfaces in addition to providing file-sharing functionality according to the principles of the present invention.

FIG. 8 depicts a start-up window 350 having a tool bar 352 and a dialog bar 354. The tool bar 352 includes conventional “Previous” and “Next” buttons which allow sequential navigation between successive pages that have been displayed in the main window 356. Clicking the Previous button (e.g., using the mouse or other pointing device 60 of FIG. 2) causes the current contents of the main window 356 to be replaced by the page that had been displayed immediately prior to the clicking of the Previous button. Thereafter, clicking the Next button causes the contents of the main window 356 to be replaced by the page that had been displayed immediately subsequently to the page displayed when the Next button was clicked. Of course, the Previous button is disabled when the main window 356 is displaying the earliest page that had been shown in the main window 356 during a given session using the illustrated file-sharing system, and the Next button is disabled when the latest such page is shown in the main window 356.

The tool bar 352 also includes Transfer, Arrivals and Sharing buttons which cause the main window 356 to display, respectively, a “transfer” view which shows the status of all files currently being retrieved from or transferred to other host computers on the illustrated file-sharing system, an “arrivals” view which shows the files that have been recently retrieved by the illustrated host computer, and a “sharing” view which shows a list of files that the illustrated host computer is currently making available to be shared or retrieved by other host computers on the illustrated file-sharing system.

The dialog bar 354 is provided to allow a user of the illustrated host computer to enter a search query specifying criteria of desired files and to then execute that search query to find files having the specified criteria. More particularly, the dialog bar 354 includes a “Find” combo box 358, an “And” combo box 360, a “Type” combo box 362, and a “Search” button 364. A user may enter a search term (e.g., a file name or artist of a desired song file) into the “Find” combo box 358 and/or a file-type designation (e.g., .mp3, .avi, .jpg, .bmp, or .gif) into the “Type” combo box 362. Optionally, a more complex Boolean search query can be formulated by entering a further search term into the “And” combo box 360. Each of the combo boxes 358, 360 and 362 has a respective drop-down button 366 which may be used to view prior entries made to that combo box.

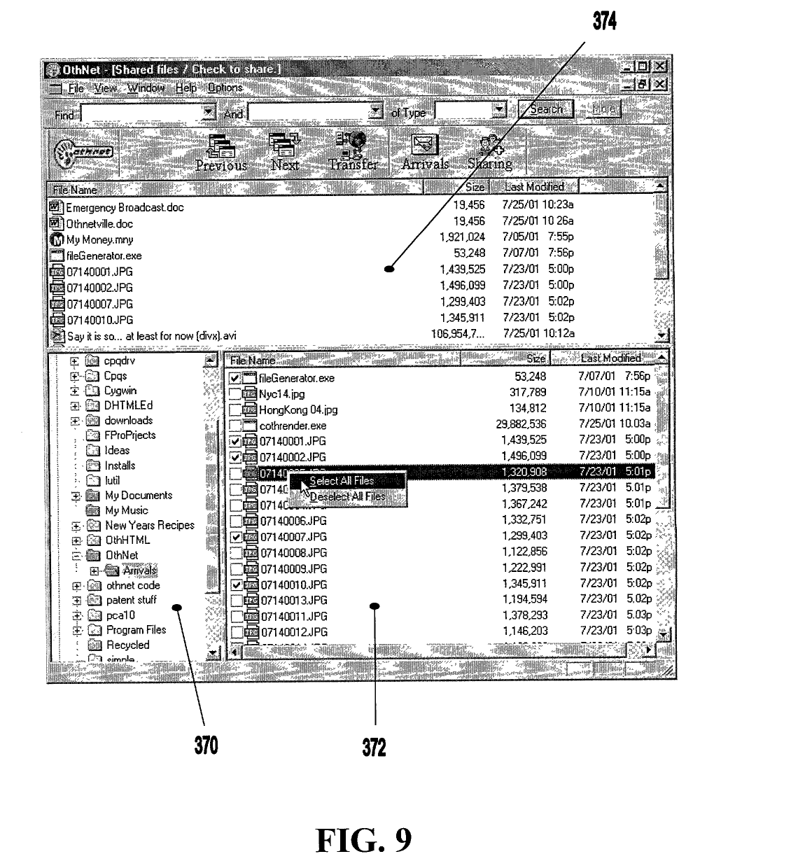

FIG. 9 shows an exemplary screen display illustrating the appearance of the main window 356 when the “sharing” view is displayed by pressing or clicking the Sharing button on the tool bar 352. As shown, the “sharing” view comprises a conventional Windows treeview control 370 which provides a hierarchical representation of the file directory structure on the illustrated host computer. The “sharing” view also includes a directory content pane 372, which shows a list of files stored in whichever directory is selected or highlighted in the treeview control 370 (e.g., the “Arrivals” directory shown in FIG. 9), and a shared files pane 374 which shows a list of files currently available on the illustrated host computer for sharing or retrieval by other host computers on the file-sharing system. As shown in FIG. 9, to the left of each entry in the directory content pane 372, a check box is provided. A user may designate a file in the directory content pane 372 as a file to be shared by checking the check box corresponding to that file, or may designate the file as one that is not to be shared by unchecking the corresponding check box. The directory content pane 372 may be provided with a context menu which can be made to appear on the monitor of the host computer by right-clicking in the directory content pane 372, and which includes a “select all files” command and a “deselect all files” command. By choosing the “select all files” command on the context menu, a user may select all files in the directory content pane 372 (i.e., check the check box for each file in the directory content pane). Likewise, a user may uncheck all check boxes in the directory content pane 372 by choosing the “deselect all files” command on the context menu.

A context menu may also be provided in connection with the files listed in the shared files pane 374. More particularly, a user may right click on any one of the files listed in the shared files pane 374 to display a context menu which may include, for example, a “remove share” command. By right clicking on one of the shared files and choosing the “remove share” command from the context menu, a user may cause the illustrated host computer to stop making that file available for sharing or retrieval by other host computers. In that event, that file will no longer appear in the shared files pane 374 of the “shared files” view shown in FIG. 9. Folders in the treeview control 370 that contain files that are available for sharing on the illustrated host computer are shown in a different color in the treeview control 370 than folders that do not contain such shared files.

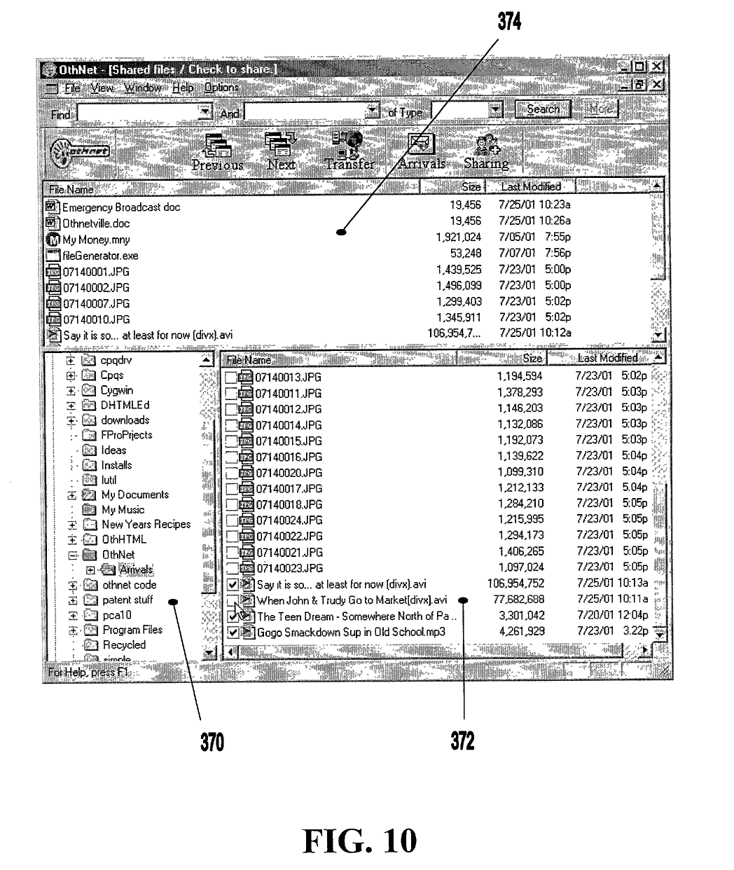

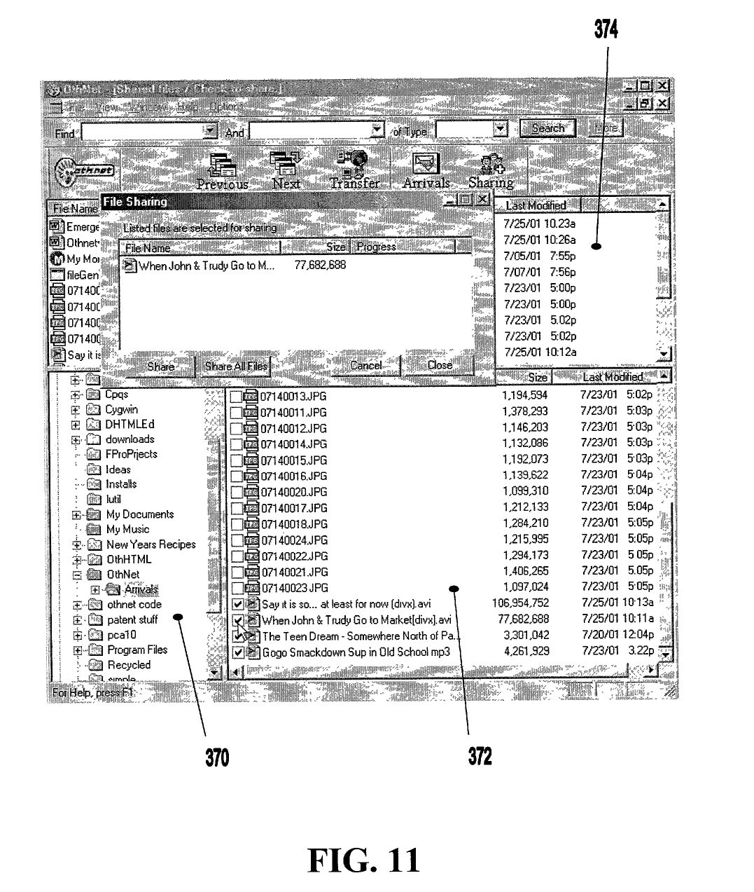

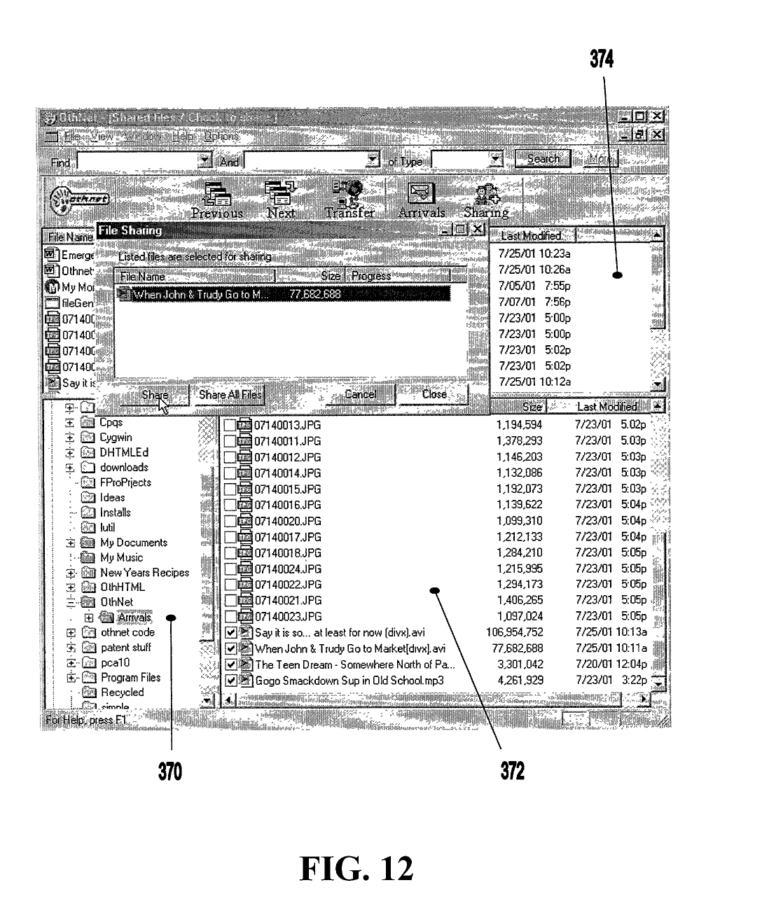

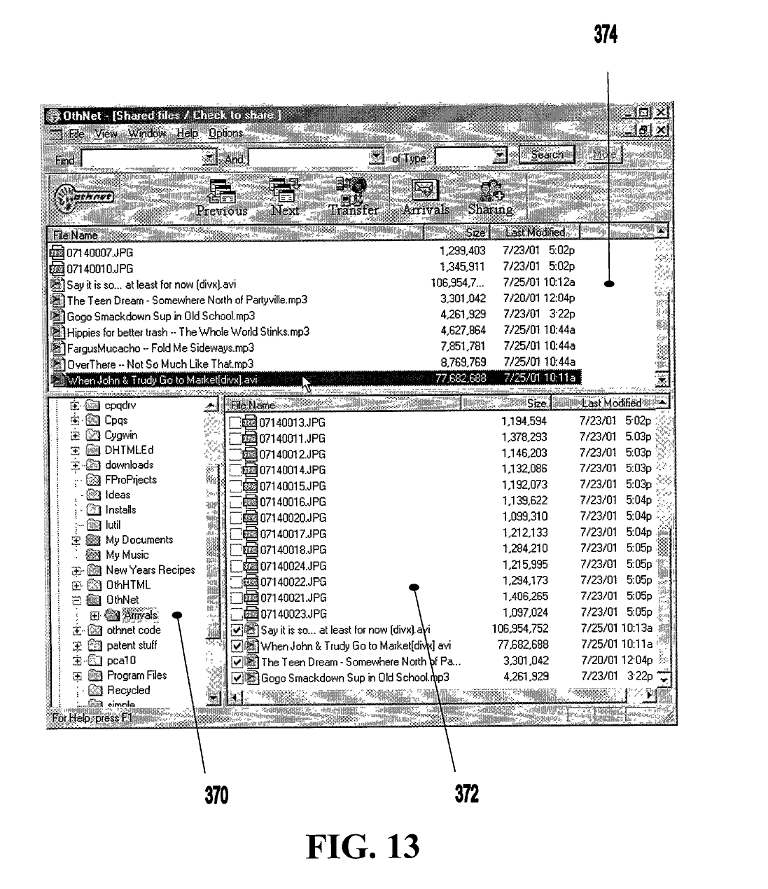

FIGS. 10-13 illustrate how a file stored on the illustrated host computer may be made available for sharing or retrieval by other host computers on the file-sharing system. As shown in FIG. 10, a user may use the mouse or other pointer control 60 (FIG. 2) to check the check box corresponding to a file in the directory content pane 372 (e.g., the file called “When John & Trudy Go to Market(divx).avi” shown in FIG. 10). When the check box for a file is checked, as shown in FIG. 11, a File Sharing dialog box appears containing a list of files selected for sharing. This dialog box also appears when a user selects the “select all files” command from the context menu revealed by right-clicking in the directory content pane 372. One or more files appearing in the File Sharing dialog box may be selected in conventional Windows fashion, and the selected files in the File Sharing dialog box may then be made available for sharing by clicking the Share button appearing in the lower left-hand comer of the File Sharing dialog box as shown in FIG. 11. Alternatively, all files shown in the File Sharing dialog box may be made available for sharing by clicking on the “Share All Files” button that also appears on the File Sharing dialog box as shown in FIG. 12. After the “Share” button on the dialog box is clicked, as shown in FIG. 12, the file called “When John & Trudy Go to Market(divx).avi” appears in the shared files list pane 374, as illustrated in FIG. 13.

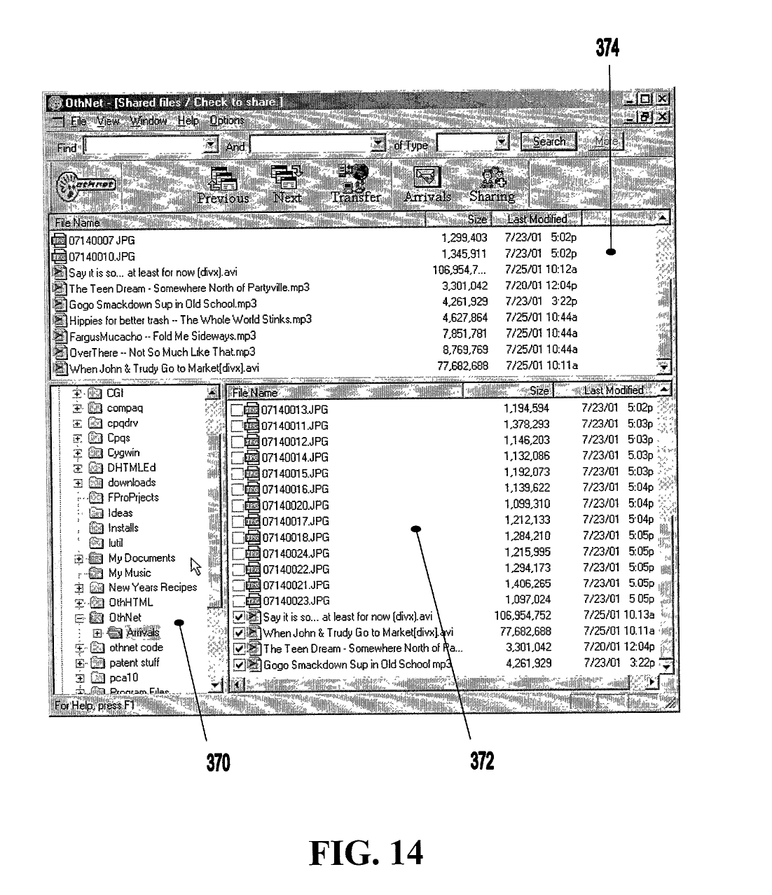

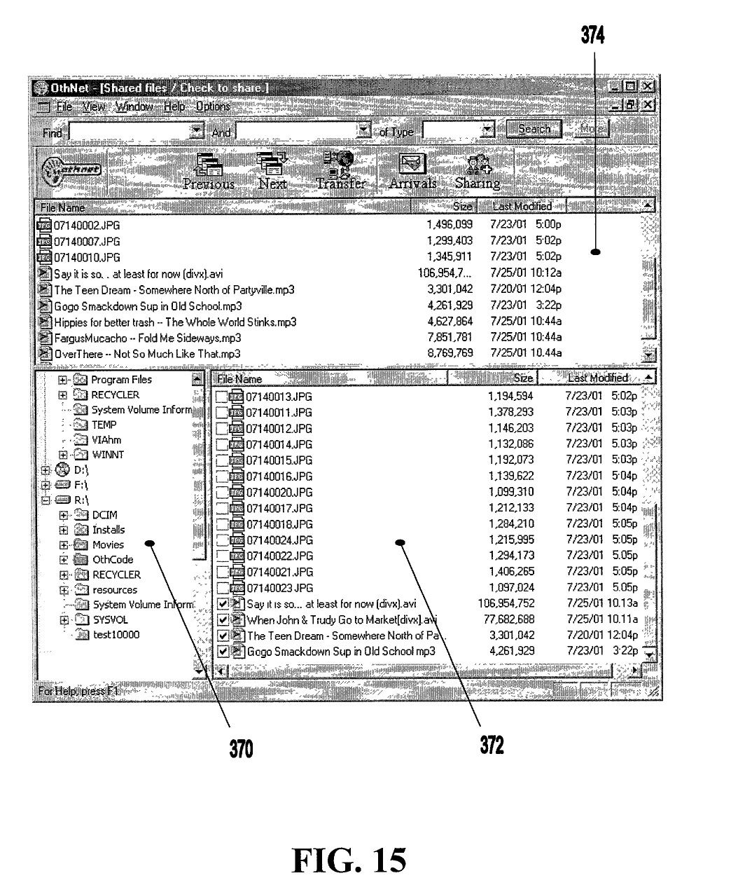

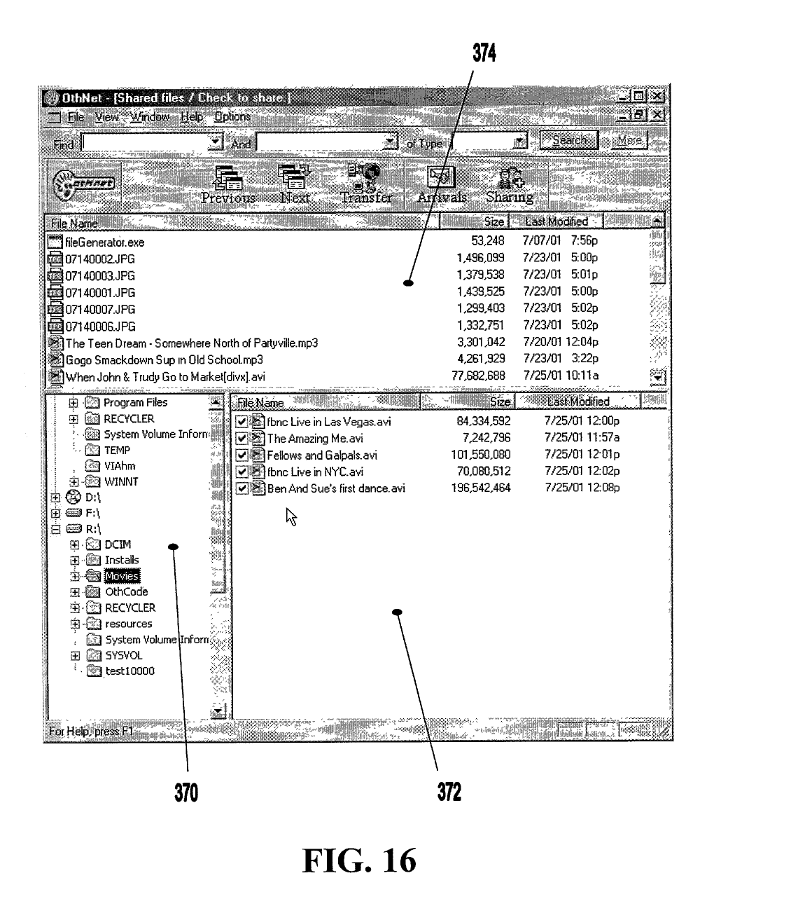

As illustrated in FIG. 14, shared files may be located in a plurality of folders or other locations (e.g., floppy, CD, DVD, or hard disc drives) on a host computer. As illustrated in FIG. 14, folders and disc drives which contain shared files are shown in a distinctive color in the treeview control 370. This is further illustrated in FIG. 15 in which the “Movies” and “OthCode” folders on the R:-drive are shown to contain shared files. As shown in FIG. 16, when the Movies folder is selected in the treeview control 370, the files contained in the Movies folder appear in the directory content pane 372, with a check appearing in the check box of each file that is available for sharing on the illustrated host computer.

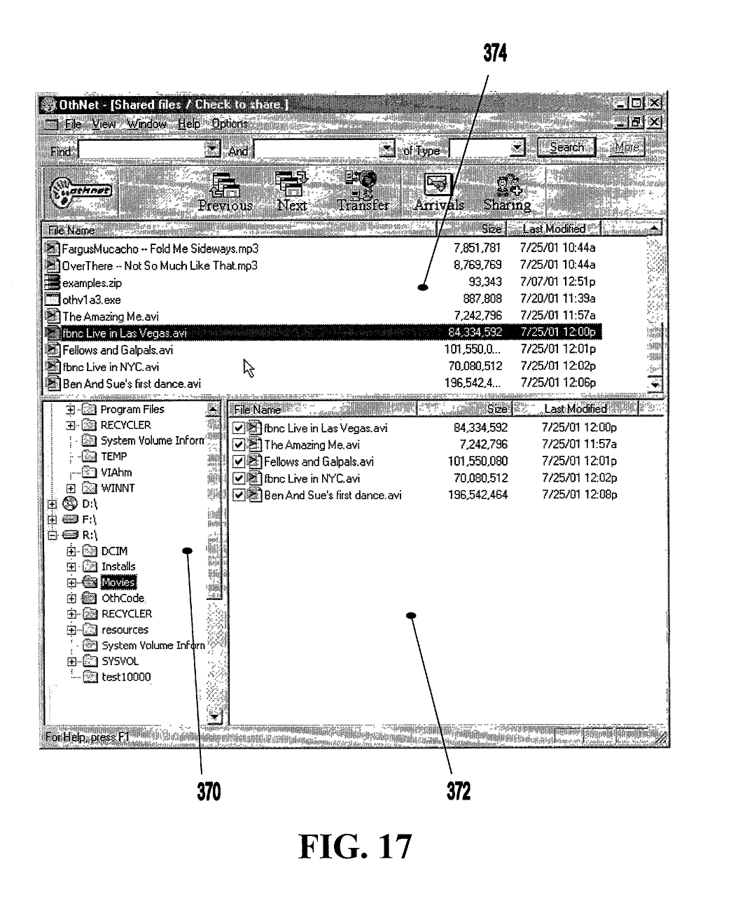

As shown in FIG. 17, each file in the directory content pane 372 for which the check box has been checked appears on the shared file list in the shared file list pane 374.

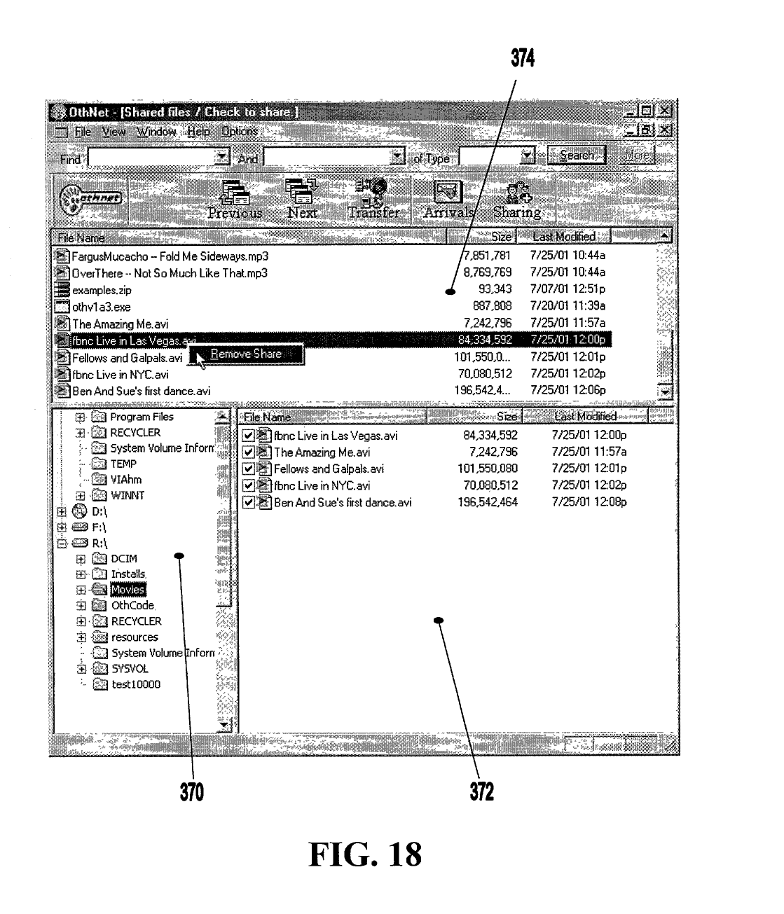

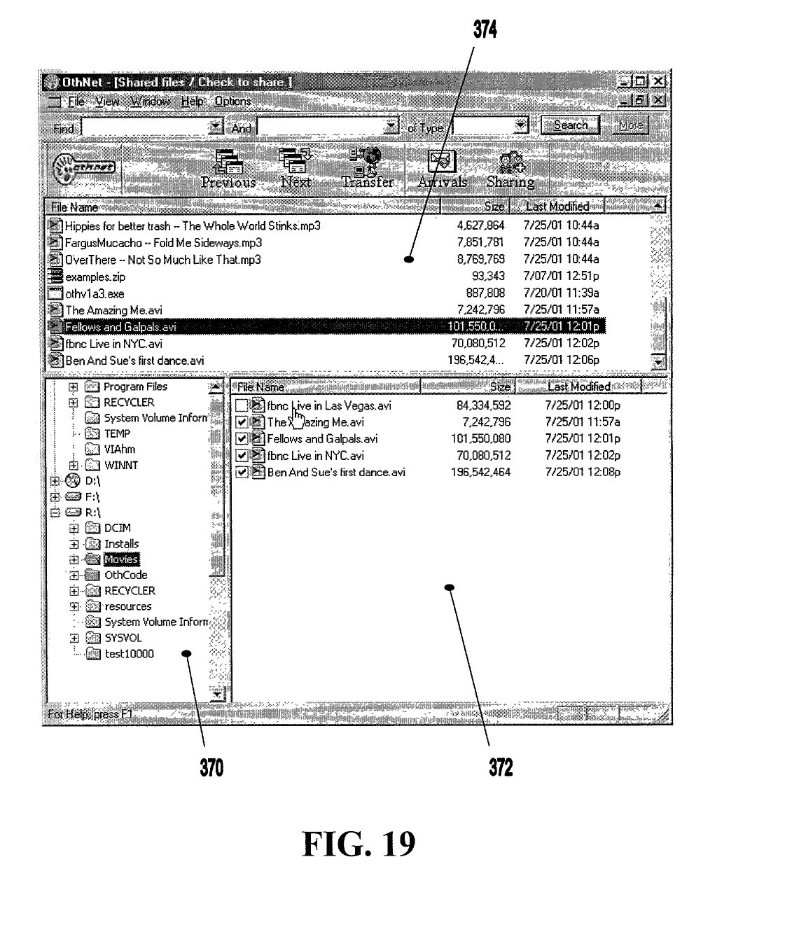

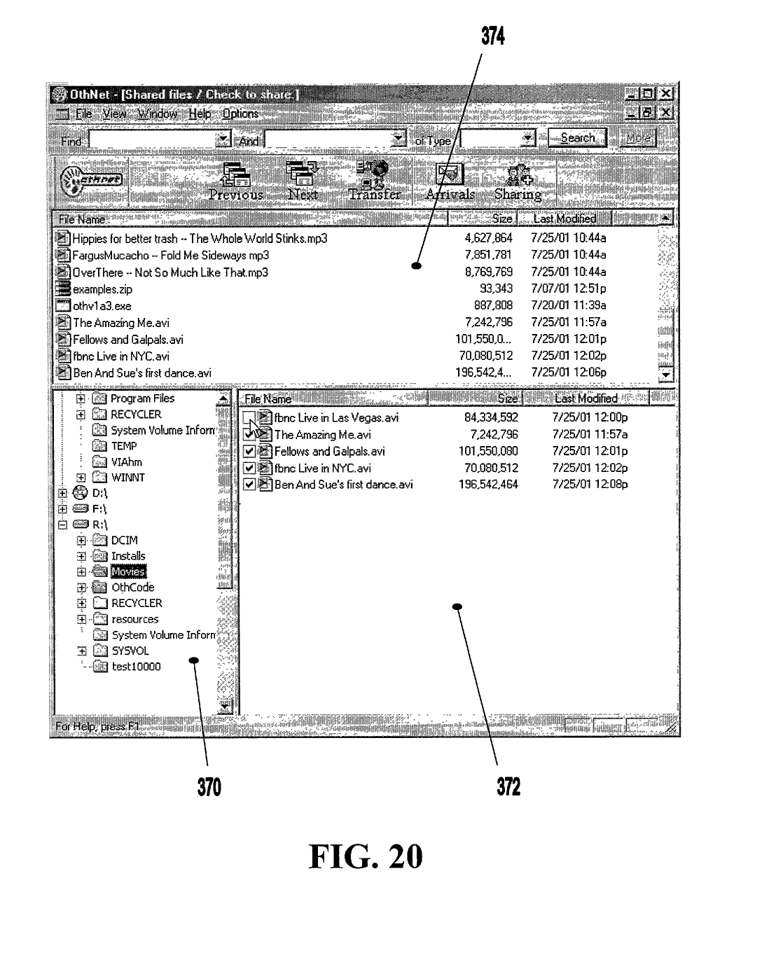

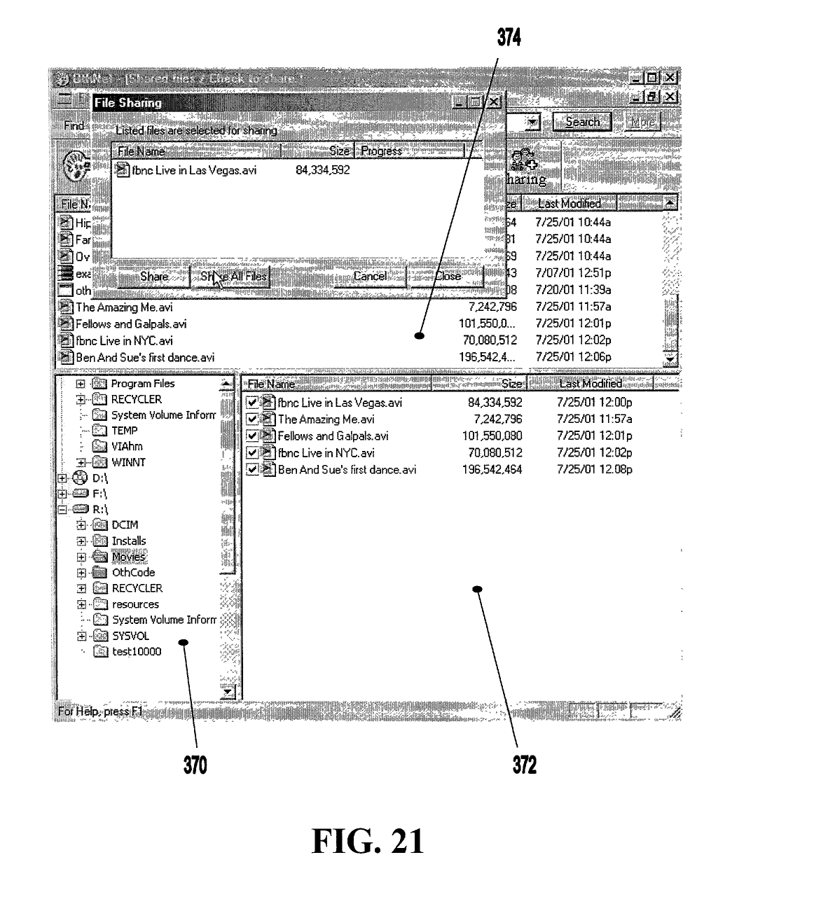

As shown in FIGS. 18 and 19, a file appearing on the shared file list, which is thereby available for sharing on the illustrated host computer, may be removed from the shared file list by right-clicking on that file in the shared file list pane 374 and selecting from the context menu that then appears, the “remove share” command. The shared file list appearing in FIG. 19 does not include any files appearing in the shared file list of FIG. 18 for which the “remove share” command was executed, as illustrated in FIG. 18. That file can be restored to the shared file list by checking the check box corresponding to that file in the directory content pane 372, as illustrated in FIG. 20, and then either clicking the Share All Files button on the File Sharing dialog box (FIG. 21) or by selecting that file in the File Sharing dialog box and then clicking the Share button.

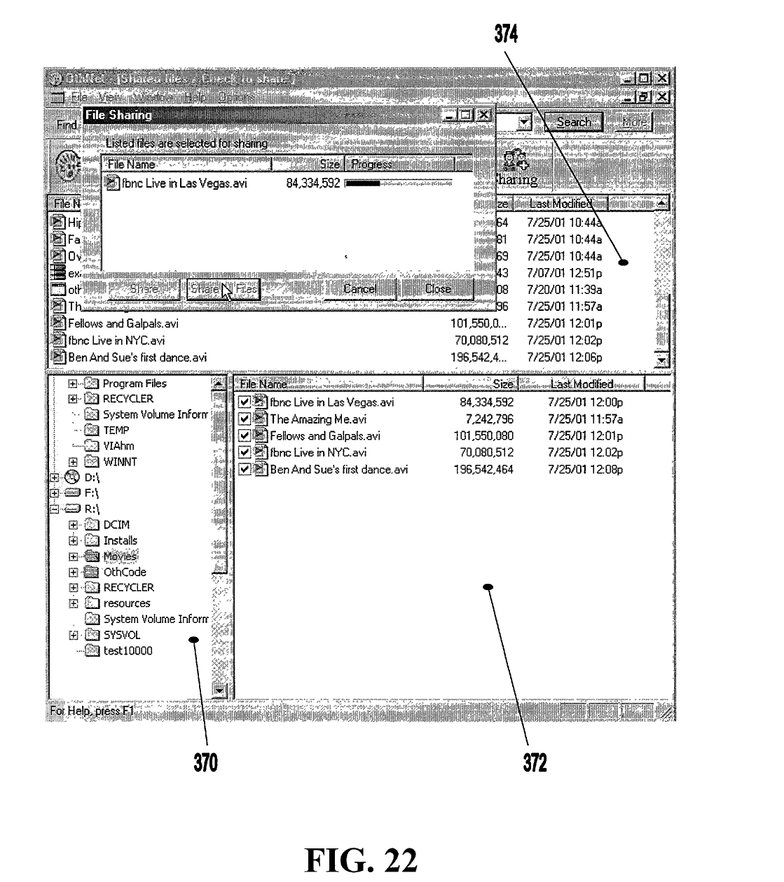

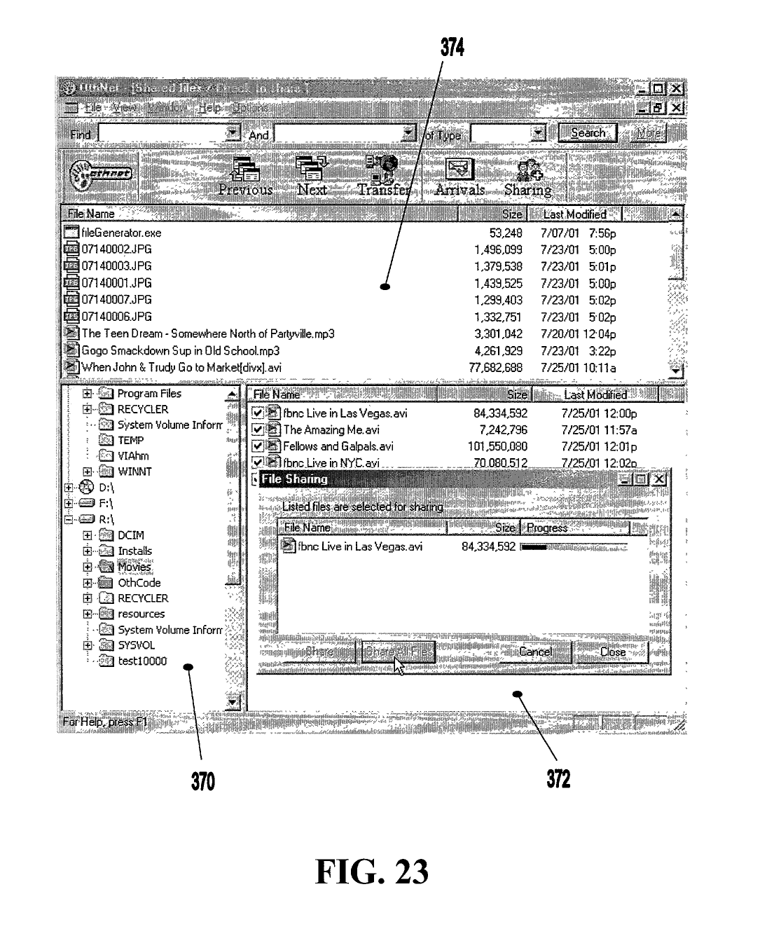

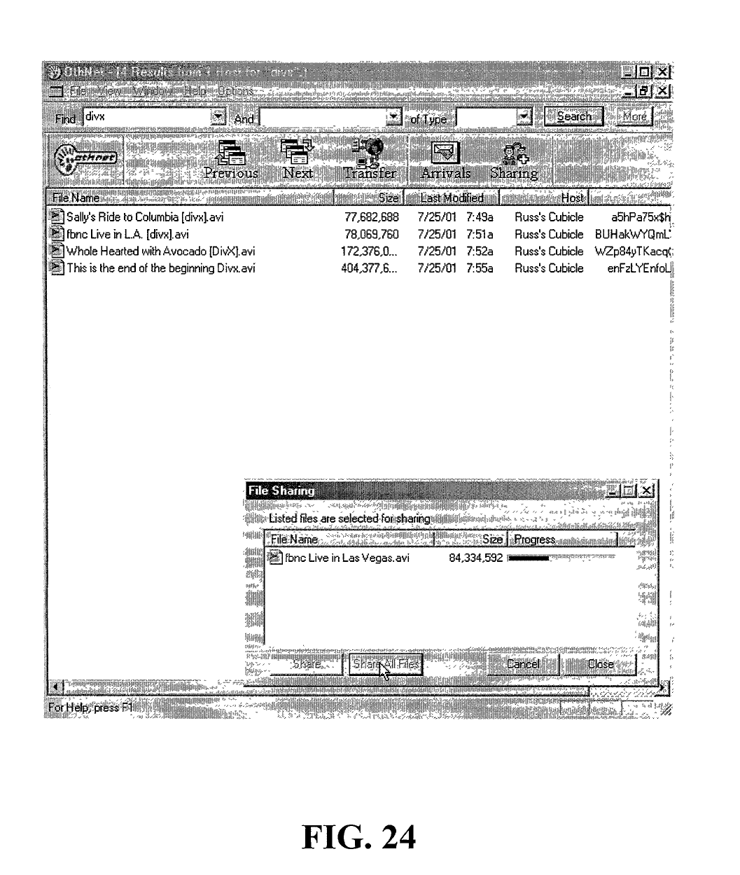

When a file is to be added to the shared files list in this manner, a unique identifier (e.g., an MD5 identifier) is computed for the file. Preferably, the identifier is based on the content of the file, such that the identifier will be unique to the file. For very large files, such as the movie files shown in the File Sharing dialog box in FIG. 22, the computation of this identifier takes an appreciable amount of time. During this time, a progress bar may be displayed to inform a user of the illustrative host computer of the progress of computation of the unique identifier for the file, as also illustrated in the dialog box in FIG. 22. In conventional Windows fashion, the File Sharing dialog box may be moved from one location on the display of the illustrated host computer to another as illustrated in FIG. 23. As illustrated in FIG. 24, during the time when a file identifier is being computed, other tasks can be performed, such as executing a search query for files containing the term “divx.”

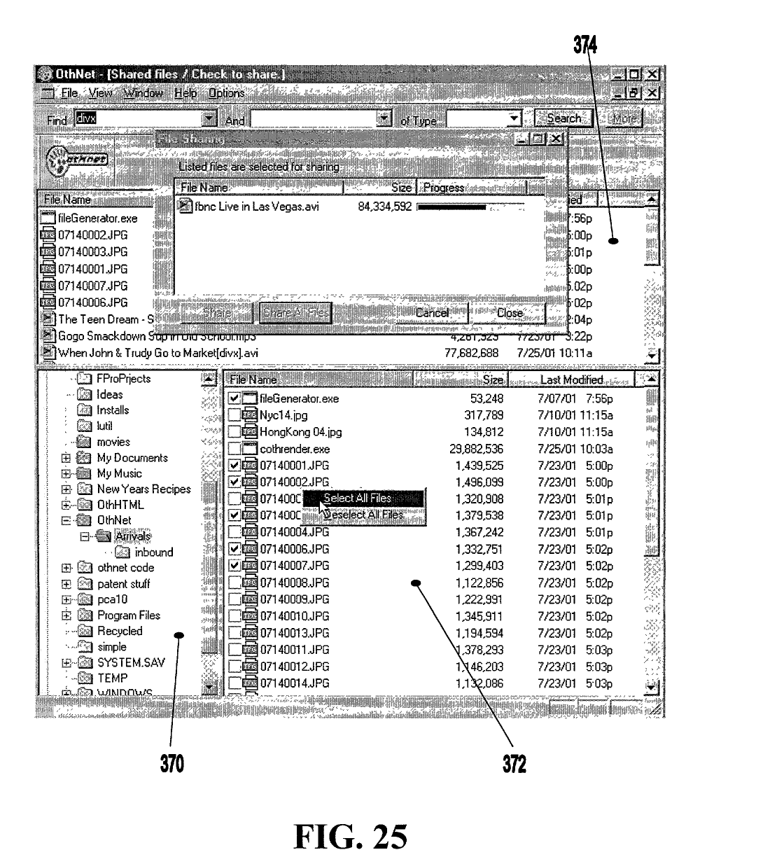

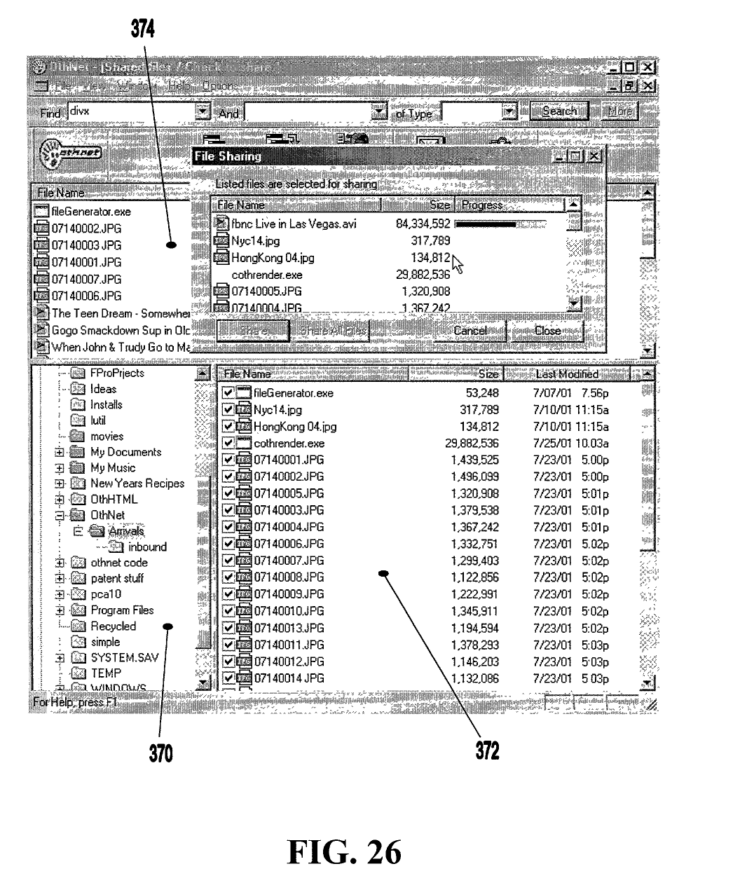

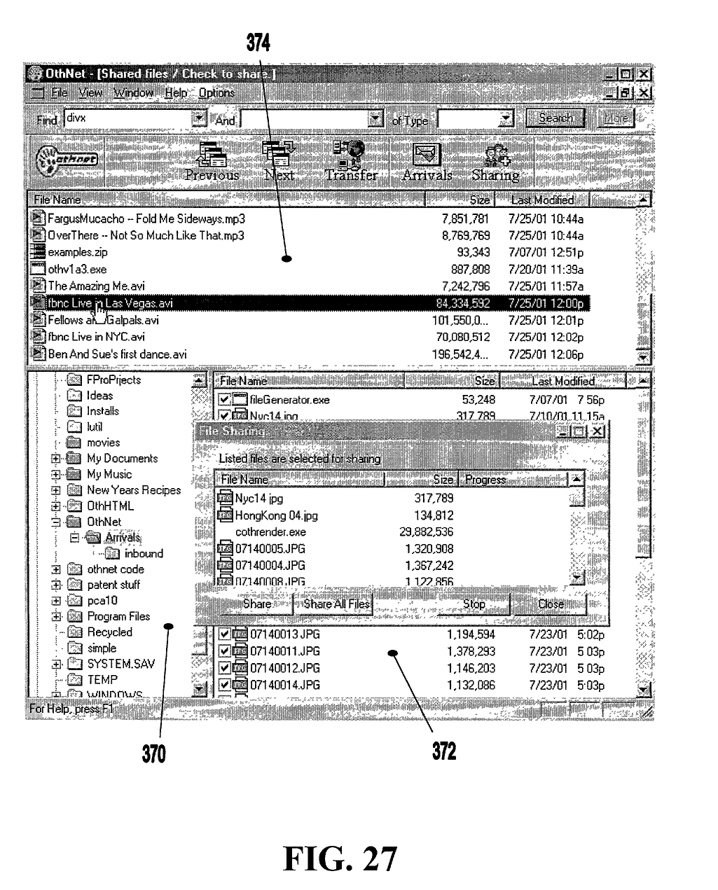

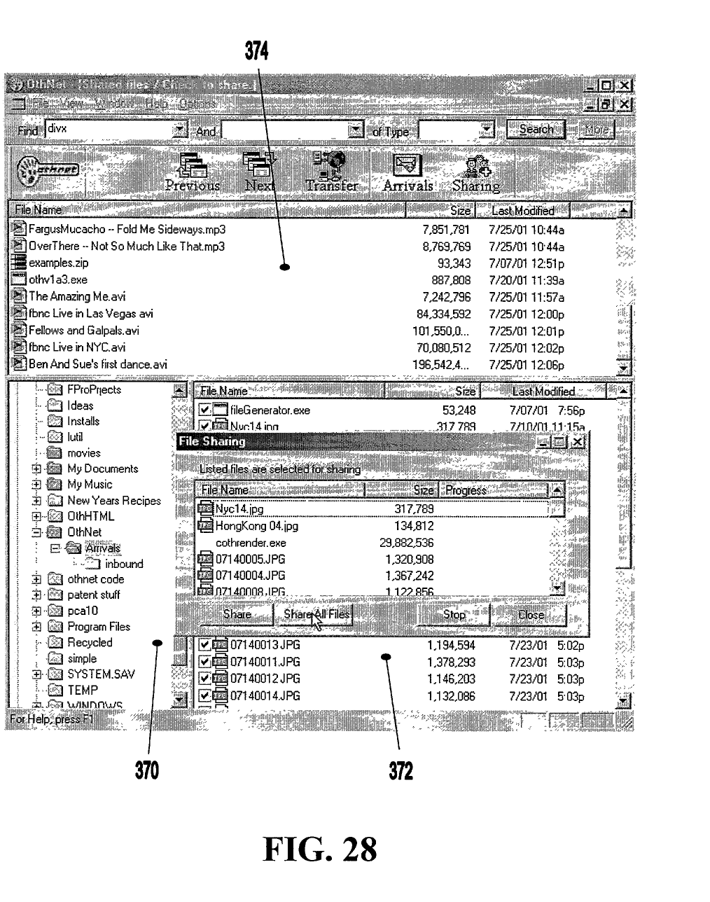

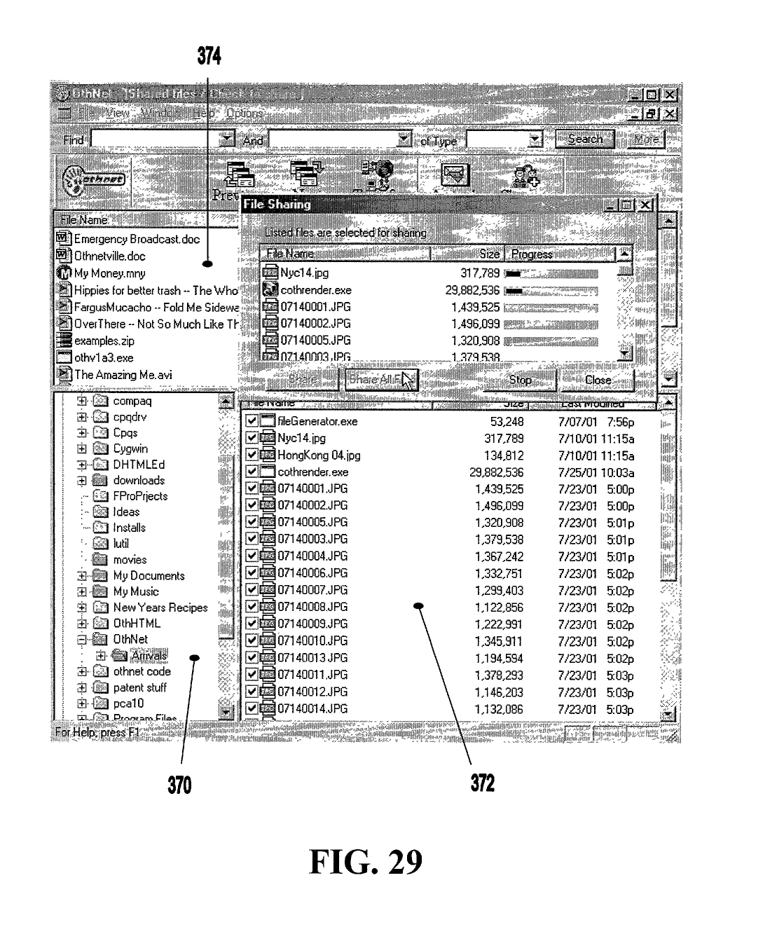

FIGS. 25 and 26 illustrate the functionality of the “select all files” command on the context menu associated with the directory content pane 372. As shown in FIG. 25, each of the check boxes corresponding to files in the directory content and 372 is unchecked and none of those files appears in the File Sharing dialog box. When the “select all files” command is selected from the context menu for the directory content pane 372, each of the check boxes becomes checked, and each of the corresponding files is added to the list of files appearing in the File Sharing dialog box, as shown in FIG. 26. According to the progress bar also shown in the dialog box of FIG. 26, the identifier for the first-listed file in the dialog box is still being computed. As shown in FIG. 27, when this computation is finished, the file is added to the list of shared files appearing in the shared files list pane 374. As shown in FIGS. 28-29, by clicking the “Share All Files” button in the file sharing dialog box, all files listed in the dialog box can be processed, such that, as shown in FIG. 29, a unique identifier will be computed for each such file.

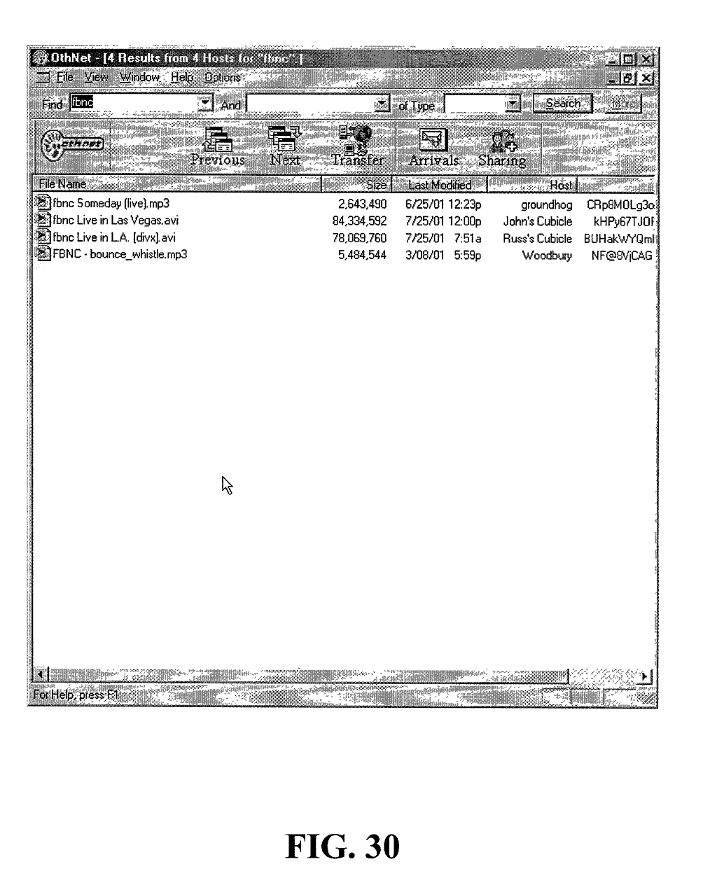

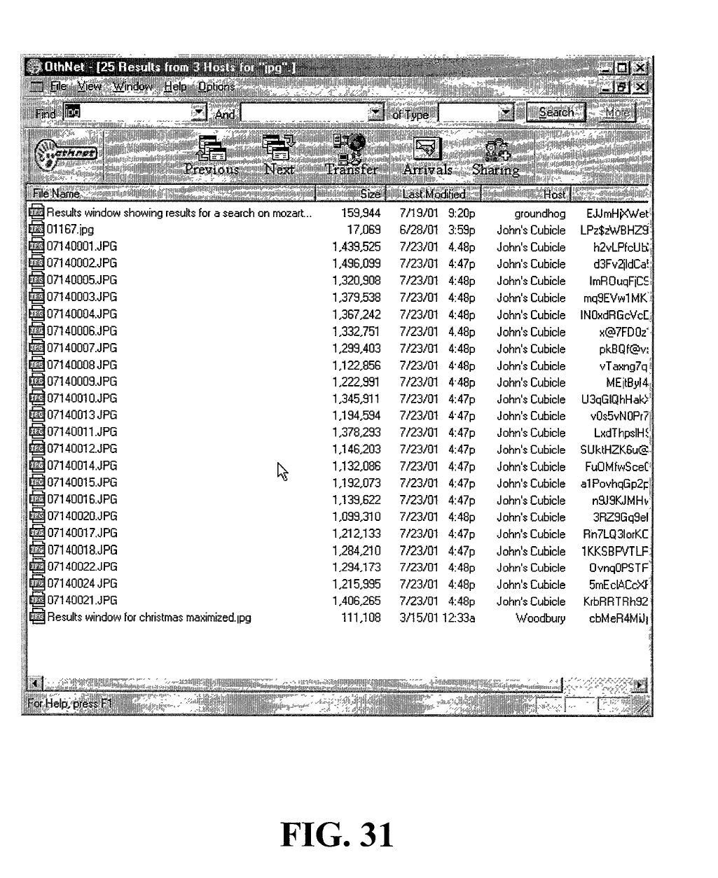

The screen display of FIG. 31 illustrates that when a search query is executed by clicking the Search button, a “search results” view appears in the main window 356, including a list of each file matching the search criteria that was found on a host computer of the file-sharing system. Results from a further search are shown in the screen display of FIG. 31. It should be noted that the results from the searches of FIGS. 30 and 31 include files from different host computers, as indicated by the host names appearing in the host column of the respective search result list of FIGS. 30 and 31 (i.e., “Fond du Lac” and “Woodbury”).

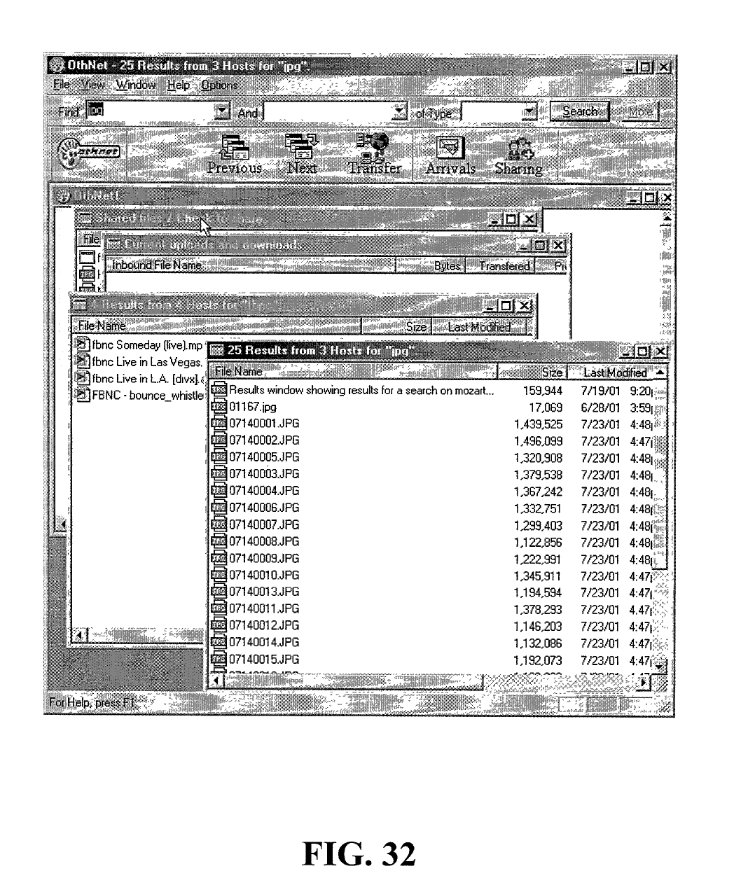

As illustrated by FIGS. 32-35, a well-known Windows multiple document interface (MDI) can be used to permit results from a plurality of searches to be maintained, each set of results being displayed in a separate window.

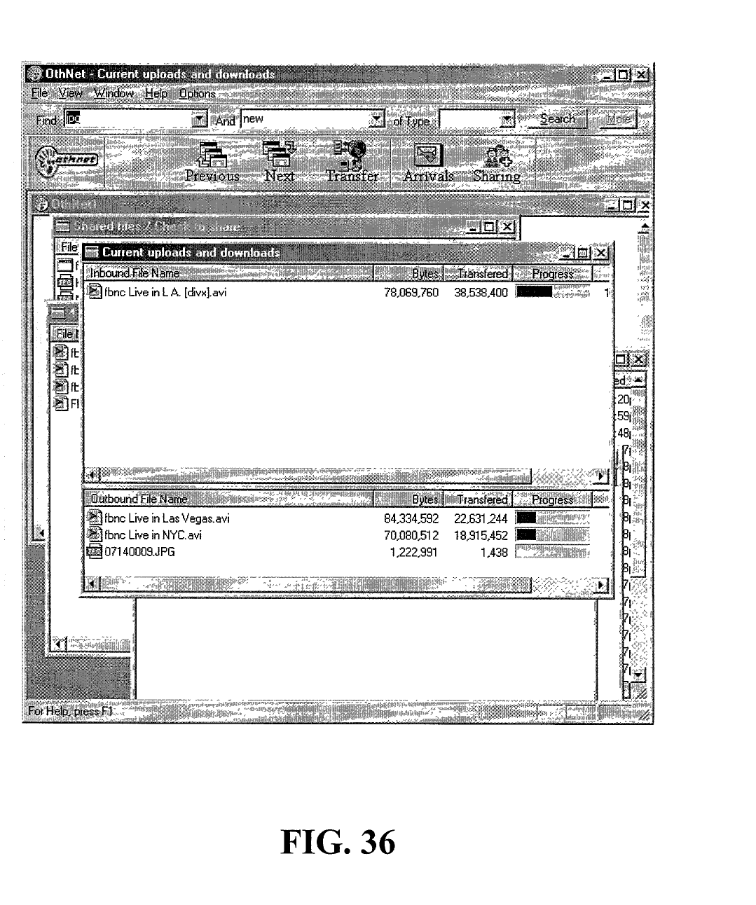

A file listed in the search results from one of these searches can be down-loaded by simply double-clicking on that file in the search result list. As shown in FIG. 36, that file will then appear on the transfer list as an in-bound file and a progress bar will indicate the progress of the transfer of the file from the source host computer where the file was found to the requesting host computer. Also shown in the “transfer” view, which may be accessed by clicking the Transfer button in the tool bar 352 (FIG. 8), is a list of outbound files being shared or retrieved from the illustrated host computer by other host computers on the file-sharing system.

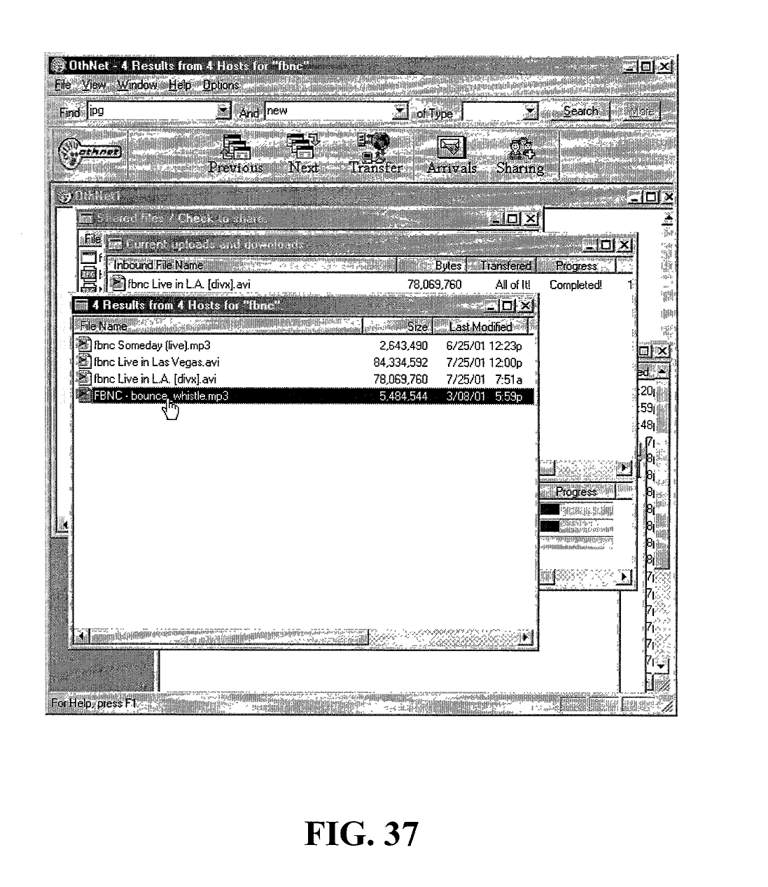

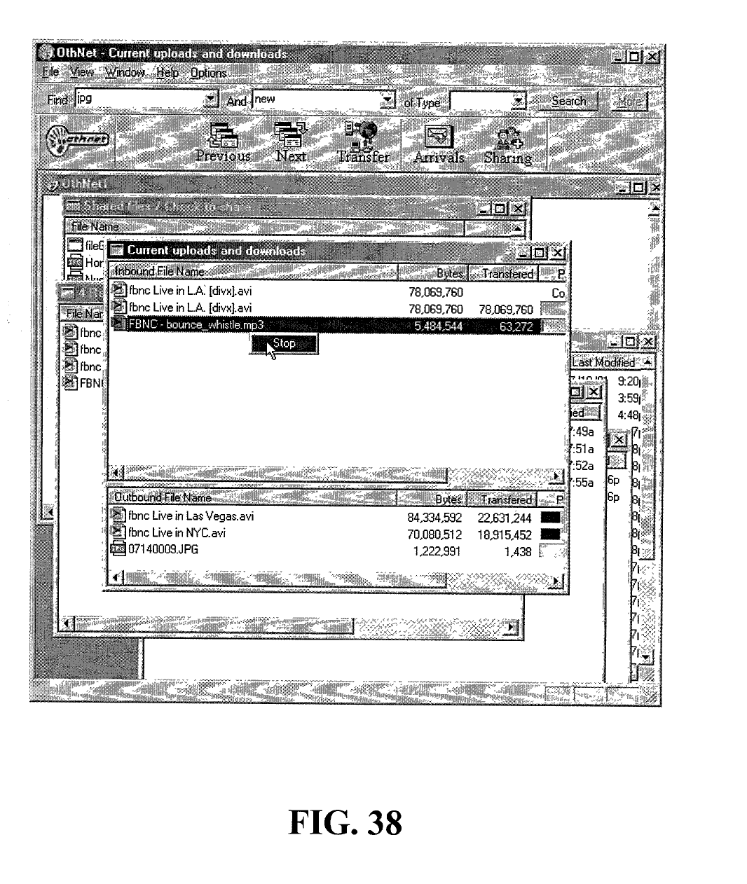

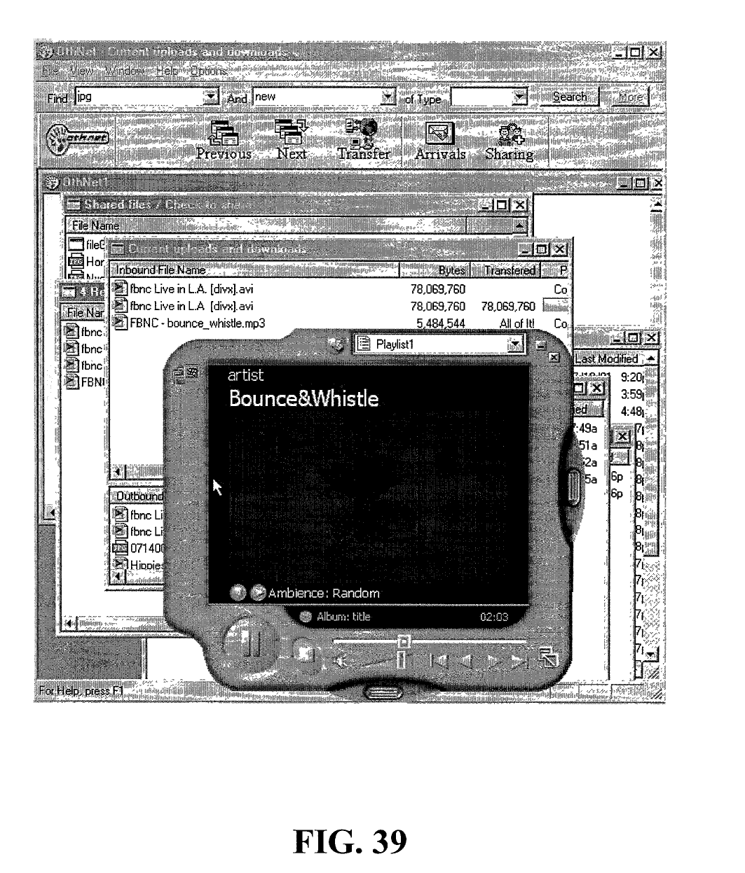

Downloading of a file is initiated by double-clicking a file in a search result list, as shown in FIG. 37. As shown in FIG. 38, while a file is being shared (i.e., while it is being downloaded or retrieved) from a remote host computer, the transfer can be stopped by right-clicking on that file in the download list and clicking the Stop button that appears. When a file being downloaded (i.e., as indicated by the presence of an entry for that file on the current uploads and downloads list shown in FIG. 39) is double-clicked, the portion of that file that has already been downloaded to the illustrated host computer is played using any suitable media playback or viewer software application. In the example illustrated in FIG. 39, the double-clicked file is a .mp3 file, and the downloaded portion of the file is played with the Windows Media Player audio processing software, which is well-known.

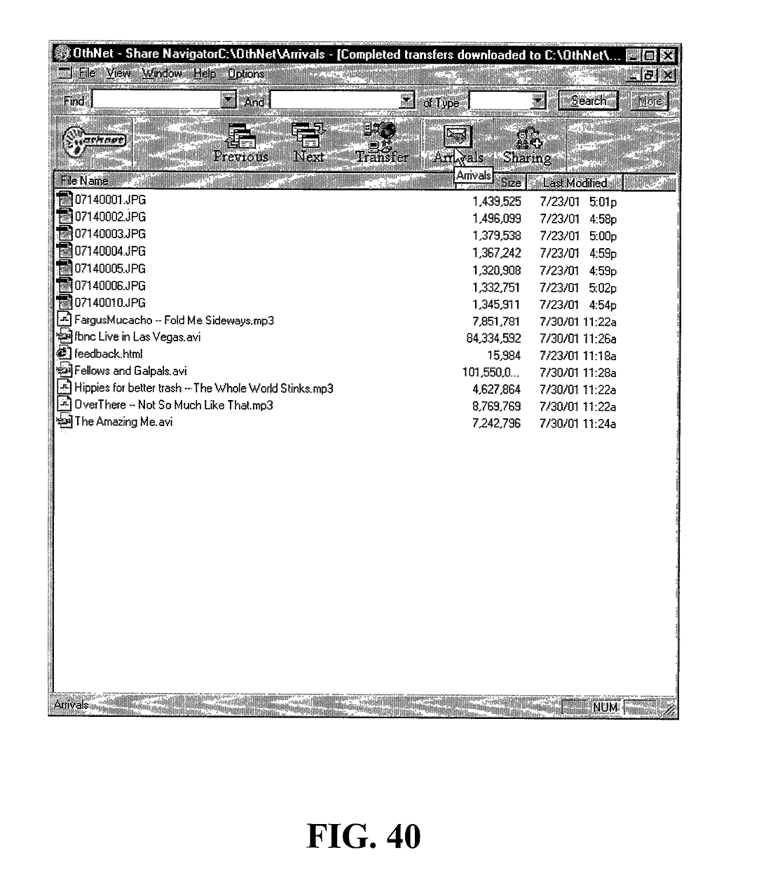

FIG. 40 illustrates the “Arrivals” view, which can be obtained by clicking the Arrivals button on the tool bar 352 (FIG. 8). After a file has been fully retrieved or downloaded in the manner described above, an entry for that file appears in the “Arrivals” view (illustrated in FIG. 40), which can be used to easily locate previously retrieved or downloaded files and to move those files to any desired storage location on the host computer that retrieved or downloaded the file.

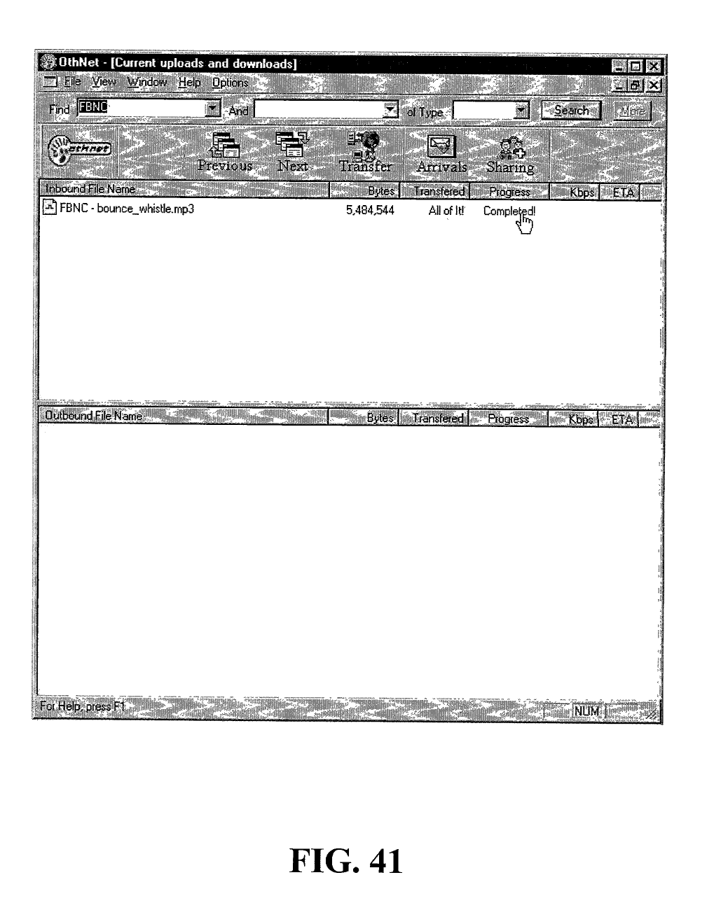

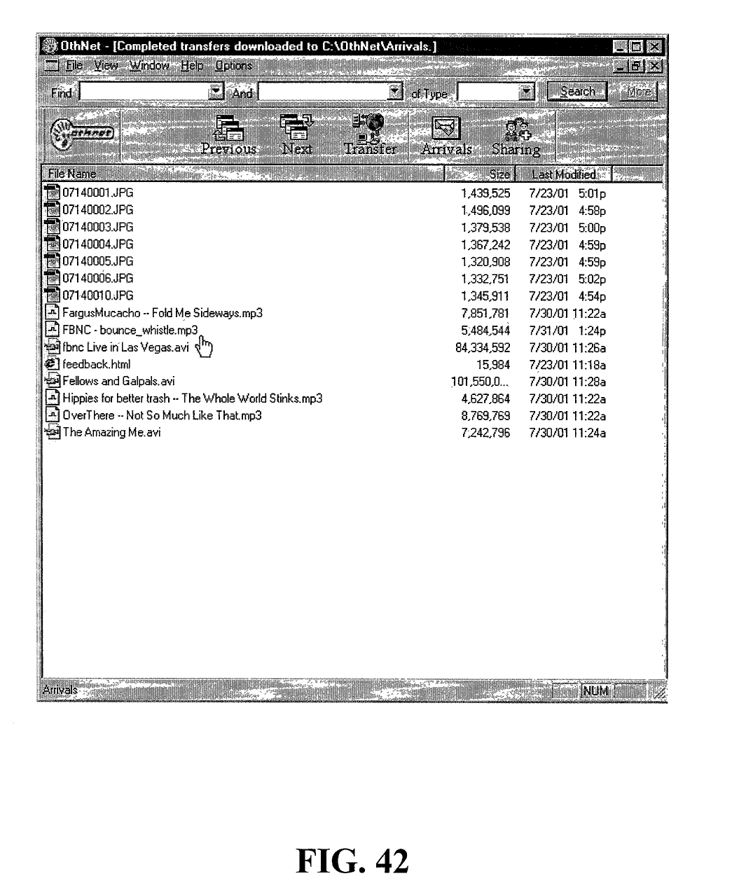

As shown in FIG. 41, the search capabilities (described above) may be used to restrict which files appear in the transfer list (described above in connection with FIG. 36) at any given time to those files that meet user-specified search criteria (e.g., in the example illustrated in FIG. 41, files having filenames that contain the search string “FBNC”). As shown in FIG. 41, downloading or transfer of the file “FBNC-bounce_whistle.mp3” has been completed, such that an entry for that completely downloaded file appears has been added to the “Arrivals” view (as shown in FIG. 42).

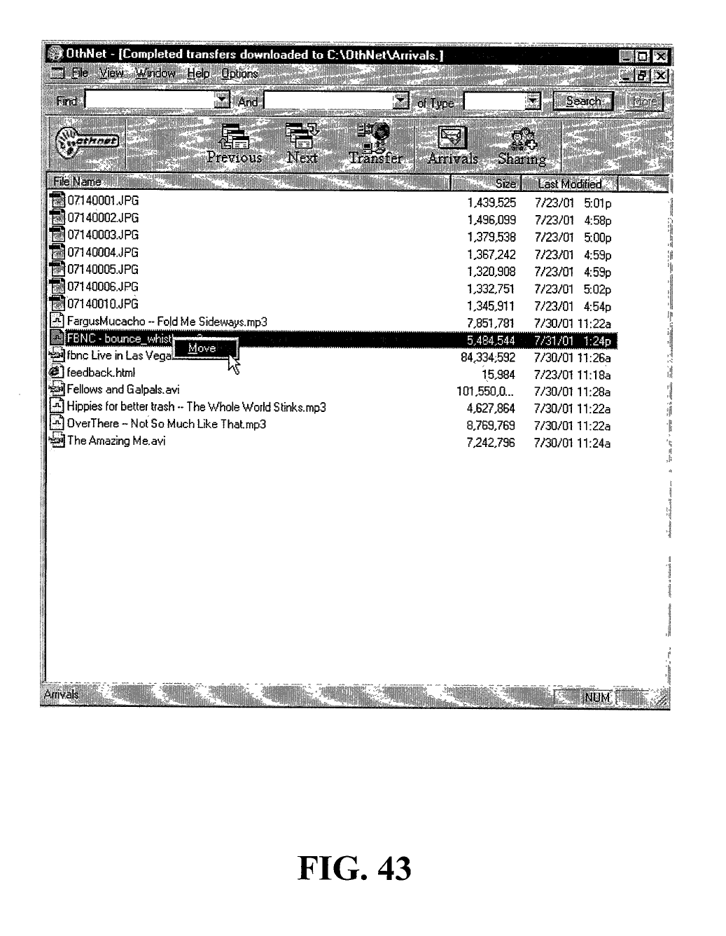

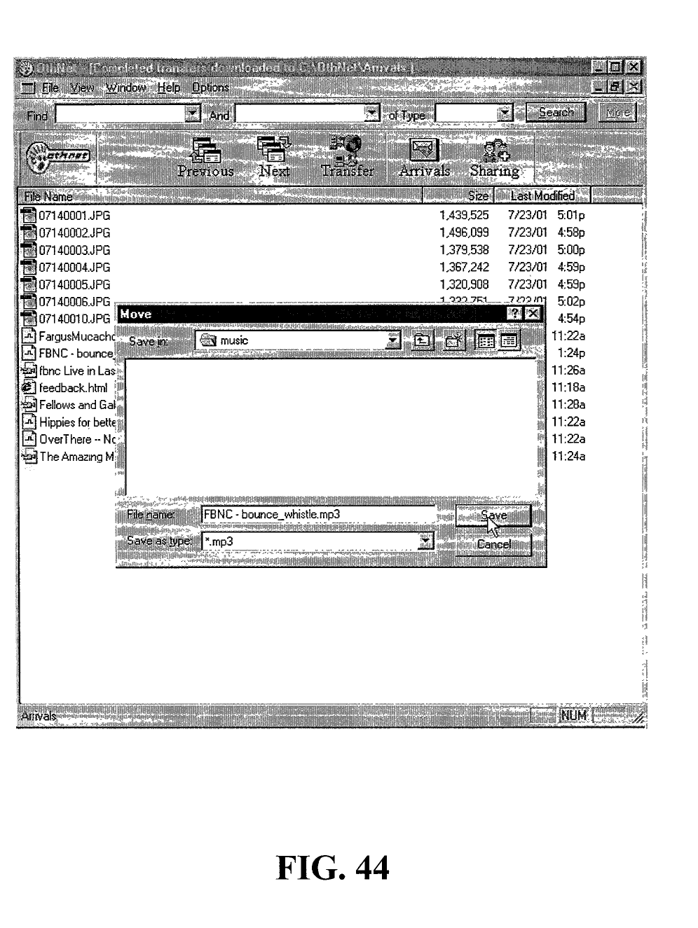

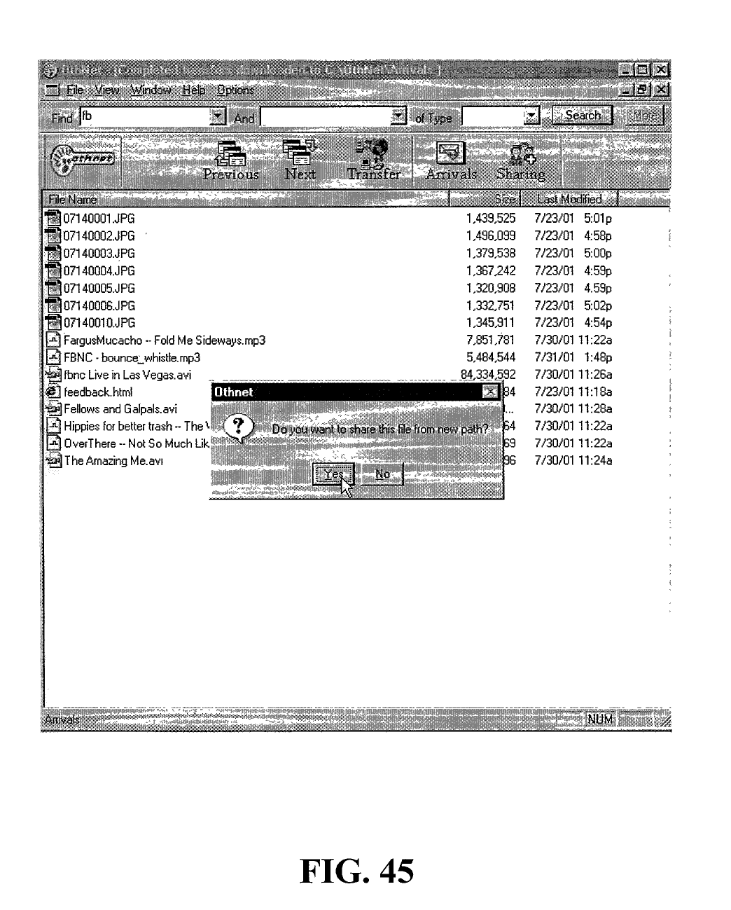

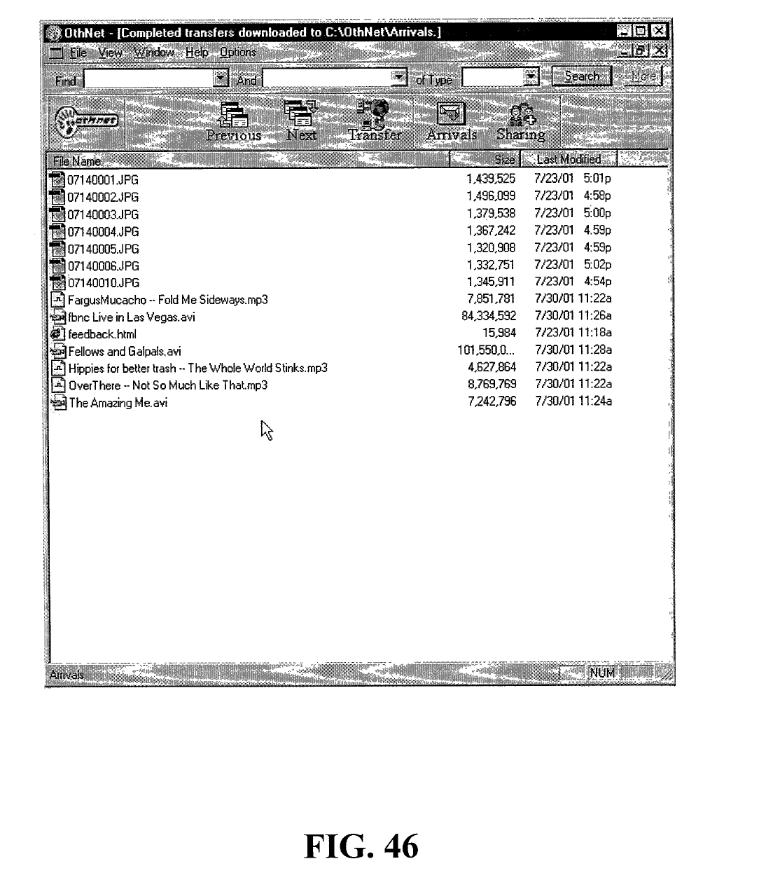

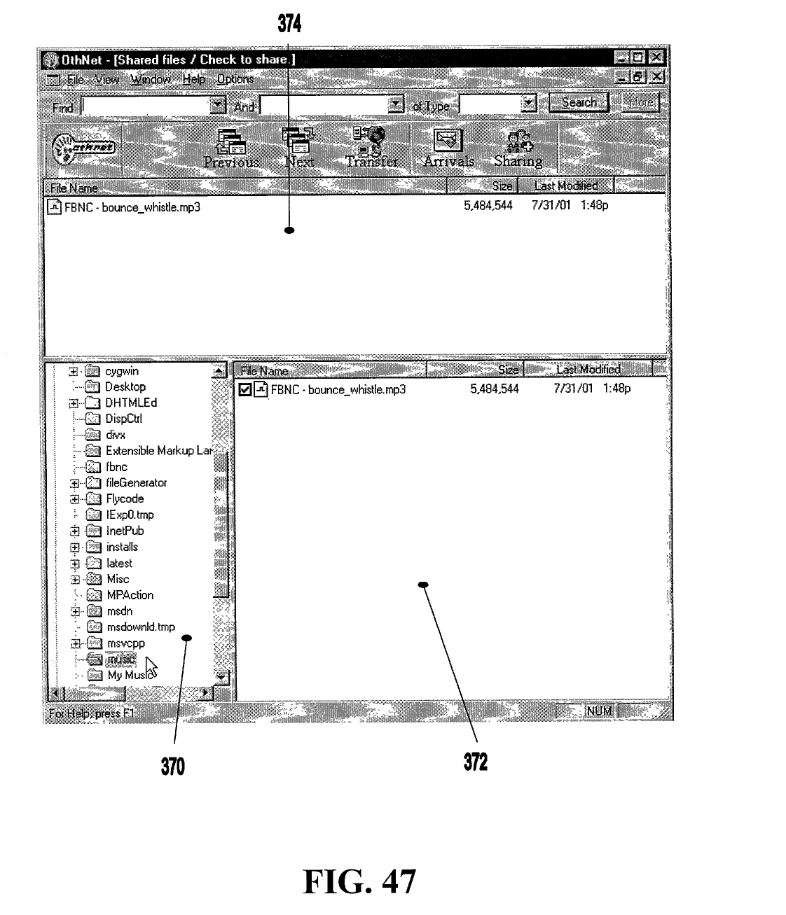

FIG. 43 illustrates a “move” command that appears in a context menu when a user right-clicks on a user-selected file in the transfer list. When the user then selects or clicks the “move” command, a common Windows “Move” control or dialog box appears, as shown in FIG. 44, to allow the user to move the user-selected file to a new location on the user's host computer. After the user specifies a location and moves the user-selected file in this manner, a further Windows dialog box then queries the user whether the moved file should be made available for sharing by other host computers from the new location (FIG. 45). As shown in FIG. 46, once a file is moved from the “Arrivals” view or the transfer list in the foregoing manner, that file no longer appears in the “Arrivals” view and no longer resides in the corresponding “Arrivals” directory on the user's host computer. FIG. 47 illustrates the “Shared Files” view (described above in connection with FIG. 9), where the moved file is now listed in the shared file list 374 as being shared if the user instructed the system to share the file from its new location (e.g., in response to the query described above in connection with the dialog box shown in FIG. 45). As described above, the directory to which the file was moved, i.e., the “Movies” directory, preferably is illustrated in a different color in the treeview control 370 to denote that the directory contains at least one shared file. The file is displayed in the directory content pane 372 with a checked checkbox to indicate the status of the file as being available on the user's host computer for sharing by other host computers.

The foregoing description is for the purpose of teaching those skilled in the art the best mode of carrying out the invention and is to be construed as illustrative only. Numerous modifications and alternative embodiments of the invention will be apparent to those skilled in the art in view of this description, and the details of the disclosed structure may be varied substantially without departing from the spirit of the invention. Accordingly, the exclusive use of all modifications within the scope of the appended claims is reserved.

What is claimed is:

1. A system for sharing files among a plurality of computers on a wide-area network comprising a first networked computer and a second networked computer, wherein a user-selected file is reliably transferred from any one of the computers to any other one of the computers using User Datagram Protocol data packets.

2. A system for sharing files among a plurality of computers comprising a first computer and a second computer, wherein a user-selected file is transferred from the first computer to the second computer via a network using User Datagram Protocol data packets, and wherein the first computer is coupled to the network via a first address-translating device and the second computer is coupled to the network via a second address-translating device.

3. A network-based file-sharing system comprising:
a first host computer and a plurality of other host computers, each host computer having a processing unit and a storage;
wherein the first host computer is programmed to generate from the plurality of other host computers a list of other host computers where a user-selected file is stored;
wherein the first host computer is further programmed to select a second host computer from the list of other host computers based on an indication of a transfer time from the second host computer to the first host computer; and
wherein the first host computer is further programmed to retrieve at least a portion of the particular file from the second host computer using User Datagram Protocol data packets.

4. The network-based file-sharing system of claim 3, wherein the first host computer is programmed to select from the list of other host computers a second host computer having the greatest responsiveness to the first host computer.

5. The network-based file-sharing system of claim 3, wherein the first host computer selects as the second host computer the host computer from the list of other host computers with the fastest transfer time from the second host computer to the first host computer.

6. A system for sharing files over a wide-area network, comprising:
a first plurality of hosts connected over the wide-area network; and
a first host having a processing unit, a storage, and a first set of machine instructions storable in the storage and executable by the processing unit for retrieving a respective portion of a user-selected file from each of a second plurality of hosts selected from the first plurality of hosts and coupled to the first host via a network.

7. The system of claim 6, wherein the first host resides on a first local-area network coupled to the wide-area network via a first address-translating device.

8. The system of claim 7, wherein the second host resides on a second local-area network coupled to the wide-area network via a second address-translating device.

9. The system of claim 8, wherein the first address-translating device is coupled to the second address-translating device only via the wide-area network.

10. The system of claim 8, wherein the first local-area network is different from the second local-area network.

11. The system of claim 6, wherein the respective portion of the user-selected file retrieved from each of the second plurality of hosts is retrieved using User Datagram Protocol data packets.

12. A system for sharing files over a wide-area network, comprising:
a plurality of hosts connected over the wide-area network;
a registry server independent of the hosts and coupled to the wide-area network for maintaining a registry containing for each of a plurality of files a message digest uniquely identifying the file and an indication of restriction status of the file; and
a first host having a processing unit, a storage, and a first set of machine instructions storable in the storage and executable by the processing unit for retrieving a user-selected file from at least one of the hosts coupled to the first host via the wide-area network;
wherein access to the file by the first host from the plurality of hosts is based on the indication in the registry of restriction status of the user-selected file.

13. The system of claim 12, wherein the user-selected file is retrieved by the first host using User Datagram Protocol data packets.

14. A network-based file-sharing system comprising:
a first host computer and a plurality of other host computers, each host computer having a processing unit and a storage;
the first host computer having generating means for generating from the plurality of other host computers a list of other host computers where a user-selected file is stored, selecting means for selecting a second host computer from the list of other host computers based on an indication of a transfer time from the second host computer to the first host computer, and retrieving means for retrieving at least a portion of the particular file from the second host computer using User Datagram Protocol data packets.

15. The network-based file-sharing system of claim 14, wherein the selecting means of the first host computer selects from the list of other host computers a second host computer having a fastest transfer time to the first host computer.

16. A method of sharing files among a plurality of computers on a wide-area network comprising a first networked computer and a second networked computer, the method comprising reliably transferring a user-selected file from any one of the computers to any other one of the computers using User Datagram Protocol data packets.

17. A method of sharing files among a plurality of computers including a first computer and a second computer, the method comprising transferring a user-selected file from the first computer to the second computer via a network using User Datagram Protocol data packets, wherein the first computer is coupled to the network via a first address-translating device and the second computer is coupled to the network via a second address-translating device.

18. A network-based file-sharing method comprising:
providing a first host computer and a plurality of other host computers, each host computer having a processing unit and a storage;
generating at the first host computer from among the plurality of other host computers a list of those of the other host computers where a user-selected file is stored;
selecting a second host computer from the list of other host computers based on an indication of a transfer time from the second host computer to the first host computer; and
retrieving at least a portion of the particular file from the second host computer using User Datagram Protocol data packets.

19. The network-based file-sharing method of claim 18, further comprising selecting from the list of other host computers a second host computer having a fastest transfer time to the first host computer.

20. The network-based file-sharing system of claim 18, further comprising selecting as the second host computer the host computer from the list of other host computers with the fastest transfer time from the second host computer to the first host computer.

21. A method of sharing files over a wide-area network, comprising:
providing a first plurality of hosts connected over the wide-area network; and
providing a first host having a processing unit, a storage, and a first set of machine instructions storable in the storage and executable by the processing unit for retrieving a respective portion of a user-selected file from each of a second plurality of hosts selected from the first plurality of hosts and coupled to the first host via a network.

22. The method of claim 21, wherein the first host resides on a first local-area network coupled to the wide-area network via a first address-translating device.

23. The method of claim 22, wherein the second host resides on a second local-area network coupled to the wide-area network via a second address-translating device.

24. The method of claim 23, wherein the first address-translating device is coupled to the second address-translating device only via the wide-area network.

25. The method of claim 23, wherein the first local-area network is different from the second local-area network.

26. The method of claim 21, further comprising using User Datagram Protocol to retrieve the respective portion of the user-selected file from each of the second plurality of hosts.

27. A method of sharing files over a wide-area network, comprising:
connecting a plurality of hosts over the wide-area network;
coupling a registry server independent of the hosts to the wide-area network for maintaining a registry containing, for each of a plurality of files, a message digest uniquely identifying the file and an indication of restriction status of the file;
providing a first host having a processing unit, a storage, and a first set of machine instructions storable in the storage and executable by the processing unit for retrieving a user-selected file from at least one of the hosts coupled to the first host via the wide-area network; and
wherein access to the file by the first host from the plurality of hosts is based on the indication in the registry of restriction status of the user-selected file.

28. The method of claim 27, further comprising retrieving the user-selected file to the first host using User Datagram Protocol data packets.

29. A computer-based system for sharing files over a computer network including a an requesting host computer and a plurality of other host computers coupled to the first host computer via a network, the requesting host computer comprising:
a processing unit;
a storage; and
a first set of machine instructions storable in the storage and executable by the processing unit for acquiring an indication of a user-selected file;
a second set of machine instructions storable in the storage and executable by the processing unit for generating at the requesting host computer from among the plurality of other host computers a list of those of the other host computers where the user-selected file is stored;
a third set of machine instructions storable in the storage and executable by the processing unit for selecting a source host computer from the list of other host computers based on an indication of a transfer time from the source host computer to the requesting host computer; and
a fourth set of machine instructions storable in the storage and executable by the processing unit for retrieving at least a portion of the particular file from the second host computer using User Datagram Protocol data packets.

30. The computer-based system of claim 29, further comprising a fifth set of machine instructions storable in the storage and executable by the processing unit for selecting from the list of other host computers a source host computer having a fastest transfer time to the requesting host computer.

31. The computer-based system of claim 29, further comprising a fifth set of machine instructions storable in the storage and executable by the processing unit for selecting as the source host computer the host computer from the list of other host computers with the fastest transfer time to the requesting host computer.
